(19) United States
(12) Patent Application Publication
(10) Pub. No.: US 2005/0263594 A1
(43) Pub. Date: Dec. 1, 2005

(54) COMPUTERIZED VOTING SYSTEM

(75) Inventor: DANIEL WILLIAM ONISCHU, EDMONTON (CA)

Correspondence Address: DAN ONISCHUK, 9628 100A ST, EDMONTON, AB, T5K 0V8, CA

(73) Assignees: THERESE ANN ONISCHUK, EDMONTON (CA); DANIEL WILLIAM ONISCHUK, EDMONTON (CA); WORLD PARK FOTO INC, EDMONTON (CA)

(21) Appl. No.: 10/908,941

(22) Filed: Jun. 1, 2005

Related U.S. Application Data
(60) Provisional application No. 60/521,625, filed on Jun. 7, 2004.

(30) Foreign Application Priority Data
Jun. 1, 2004 (CA) 2,469,598

(51) Int. Cl. G06F 17/60

(52) U.S. Cl. 235/386; 705/12

(57) ABSTRACT

Any business, individuals, groups of people, or government that is Officially facilitating the voting process use sources of computer data and other data to create lists of every eligible Voter. The List of Eligible Voters contains the name and physical mailing address for each Voter. The Official host then arranges for printing of mailing envelopes containing specially designed ballots to the Voters. Each MASTER Ballot has two parts—a PRIMARY Ballot and at least one RECEIPT Ballot. For each MASTER Ballot, both the PRIMARY Ballot and RECEIPT Ballot(s) share an identical, unique group of symbols as a correlating identifier. The identifier (RSID) is randomly generated to be unique and rare, so as to make any ballot difficult to counterfeit. To maintain privacy, Voters exchange ballots before voting at least once within a voting region. Completed PRIMARY Ballots are mailed or otherwise delivered to Official host on or before the due date for verification, recording, tallying and publication. For example, a telephone, facsimile (fax) machine, or computer connected to the Internet can be used to cast ballot votes. By referring to any RECEIPT Ballot having the same the unique RSID as the PRIMARY Ballot, any Voter can use a telephone or a computer connected to the Internet to enquire, verify or report errors as to ballot processing, records of ballot vote selections, or published tallies of ballot votes or other information published by Voting Session Officials.

### TECHNICAL PROBLEMS RESOLVED

1. improve accuracy, time and money savings of compiling voter lists;

2. extend the process of voting to encompass more voters by providing significantly easier access to the process of voting;

3. extend the process of voting to encompass candidates, proposals or any combination of candidates and proposals;

4. maintain security, privacy and anonymity of voter ballots cast;

5. enable voters to anonymously verify and correct the accuracy of official records of any ballots they have cast, by using electronic devices connected to communications networks;

6. prevent counterfeit ballots by special security elements and methods;

7. enable voters to verify ballots authenticity and validity by using electronic devices connected to communications networks;

### INVENTION USES

1. Elections to select political candidates to Government duty.

2. Corporate group of stockholders vote to elect a Chief Executive Officer.

3. Public vote on passing a Government Bill Proposal as a Public Law.

4. Stockholders vote to accept or reject proposals on business activities.

### BACKGROUND OF THE INVENTION

Although this invention was conceived without reference to existing patents, it should be noted this invention differs from several existing patents significantly. The purpose of this patent is to overcome the following issues and limitations of existing patents:

### CROSS REFERENCE TO RELATED APPLICATIONS

| | | |
|---|---|---|
| 3141976 | May 1974 | Hune |
| 6688517 | Feb. 2004 | McClure |
| 6640138 | Apr. 2003 | Hall & Schwartz |
| 6457643 | Oct. 2002 | May |
| 6722562 | Apr. 2004 | Weiss |
| 6726090 | Apr. 2004 | Kargel |

With regard to Hune U.S. Pat. No. 3,941,976 and McClure U.S. Pat. No. 6,688,517 the PRIMARY component of those inventions is design of electronic devices and circuitry to record votes. Hune also discounts the accuracy of scanning paper ballots with the remarks; The disadvantages of paper ballots in most large elections are readily apparent. Each vote from each ballot must be manually tallied and accumulated. Apart from the time required, the opportunities for even honest errors is evident. Accordingly, many voting authorities now use automatic techniques for accumulating votes. Other automatic counting approaches include the use of manually punched business machine cards and paper ballots marked with a special marking device. Business machines then scan the business machine cards or paper ballots to accumulate the vote totals. These techniques are subject to not insubstantial errors. A comment which was likely true for the state of the technology in 1974. McClure also derides use of paper ballots. What Hune wrote in 1974 is applicable to this patent—“The present invention elates in general to automatic vote recording and more particularly concerns novel apparatus and techniques for reliably, rapidly and securely accumulating votes manually entered by Voters with relatively economical apparatus characterized by extreme flexibility. The invention is especially useful in connection with an easily programmed electronic computer for recording the votes”

Hune did not foresee the complexity of modern computer software and the security issues such as computer virus and worm programs. The solution to those problems is a continually evolving and is beyond the scope of this patent application; however, it should be noted, that there are many ultra-secure computer networks in operation today that are very reliable which could be adapted to enable use of ideas, steps and methods set forth in this patent application.

Although Hall & Schwartz et al—U.S. Pat. No. 60,540,138 refer to the use of scanning devices and scannable barcodes, the barcodes themselves are not easily human readable, nor easily compatible with translation for telephone use. Furthermore, the process of Hall & Schwartz et al implicitly violates Voter privacy as the there are means to link any persons vote to the ID number they are assigned for voting, such as visual observations of ID number, electronic interception of a generated ID number. Any Voter can also be linked to a ballot by witnesses as to the date, time and place where the ballot is cast.

The same implication of linking of a specific ballot to a specific Voter can also be said for the patent of Way—U.S. Pat. No. 6,457,643 Way remarks “7. A ballot paper as claimed in claim 5 or claim 6 wherein the unique identifier is generated from a Voter's position on an electoral roll, the date and time the ballot paper was issued, and an external value contributed by a key.”; Thus Officials could know when & where the specific ballot identifier was issued to a specific person, therefore the alleged privacy is penetrable through observation and deduction. Electronic surveillance technology could also be used to detect electromagnetic waves emitted from devices issuing IDs which could then be sent toportable computer that use software to determine an ID.

The patent of Weiss U.S. Pat. No. 6,722,562 involves the use of Automated Teller Machines also links a Voter to a specific card and their personal identity number (PIN). Although ATM voting cards could be exchanged among Voters, ATM machines have cameras which would record the Voters face, along with the location, date and time of the ballot cast from that particular ATM. The massive coordination of banks with government. computer software adaptation and privacy issues may also prevent adopting this method.

Furthermore, as many know from personal experience, the magnetic field of present technology ATM cards may be corrupted by mistake or intent.

Due to some similarities, it should be re-emphasized that this patent was developed without prior knowledge of Kargel U.S. Pat. No. 6,726,090. Yet, this invention overcomes many disadvantages of Kargel and other patents by specifically defining:
a. the unique methods of creating computer data lists to identify eligible Voters;
b. the methods of distributing ballots to eligible Voters;
c. the unique methods of providing Voters with information to facilitate voting;
d. the unique methods to decouple Voters from specific ballots to provide vote anonymity;
e. the methods of collecting ballots from Voters;
f. the unique method of telephonic voting that does not enable the Official person to link a specific ballot ID to a specific Voter (in Kargel how does the Official person know the Voter is legitimate and still protect the privacy of that Voter who provides an identifiable ballot?)
g. a unique specific method to assign a unique, random identifier to all ballots;
h. the methods to distinguish PRIMARY Ballots and their duplicates to prevent multiple voting using both ballots at different voting locations;
i. the methods of using at least one computer or telephone and at least one communication network; to facilitate ballot issuance, ballot replacement, ballot Validation, and private verification of voting;
j. unique methods of ensuring ballots may not be counterfeited, to prevent excessive, unfair influence in the overall voting results;
k. unqiue methods to provide ballots with Security Elements to assist with Authentication;
l. methods of providing symbols and data on the ballot to reduce human processing;
m. unique methods of voting to include people, proposals, or, any combination of people and proposals.
n. unique methods of providing an expiry time and/or date on the ballot to limit ballot use;
o. unique methods to provide additional information on the ballot to faciliate accurate completion;
p. unique methods of providing information to help the voter via a Voter Information forms and/or Voter Data forms;

In 1974 Hune wrote: “It is an important object of this invention to provide achieve the following:—improved apparatus for voting automatically that overcomes one or more disadvantages of prior art apparatus, such as those enumerated above.”

Such is the purpose of this patent application.

Hune—U.S. Pat. No. 3,941,976: “Election results accurately reflecting the choices made by the Voters is vital to the democratic process in all kinds of elections, whether they be for governmental offices, changes in laws, or in private elections, such as for offices of an organization. (a.) one or more of the preceding objects with apparatus that facilitates accommodating write-in votes. (b.) enable the Voter to see vote selections before they are entered into the accumulated total and make changes; (c.) maintaining the secrecy of the ballot. (d.) maintaining an accurate count of not only the votes cast by a Voter but also the number of selections which the Voter could but did not choose (blanks.). (e.) signals representative of votes in such a manner that a computer may function simply as an accumulator of the votes for each candidate.” (f.) to prevent a Voter from selecting more than a predetermined authorized number of candidates for a particular office.”

To which this patent adds: (g.) to assist the principles of democracy by making it easier for people to participate in voting, thereby extending the representation of Voters to better reflect public choices. (h.) to ensure the integrity of the ballots so that the processing and voting selections may be verified and adjusted by the Voter and Official persons upon detection of any processing errors after the ballot has been processed. (i.) use of a Random Symbolic ID (RSID) and security elements to ensure the integrity of the ballots so that a MASTER, PRIMARY, or, RECEIPT Ballot may not be easily duplicated, in any quantity to significantly affect the overall percentage of vote tallies, and any such duplicates would be immediately detected and removed for further investigation and authentication so as guarantee the integrity of the final tally and certified results.

### SUMMARY OF THE INVENTION

The present invention provides a method and system that improves and extends the tasks of certifying eligible voters, voter participation, ensuring accurate vote reception, tallying, verification, and error reporting. The major components of the method involve providing specially designed Ballots to a group of voters; recording Ballots received from the group of voters; tallying the votes from Ballots that were authenticated and validated; publishing the vote tallies from the group; verifying the published Ballot votes and tallies on a per-voter basis; and certifying the groups tallied Ballot votes were accurately recorded and counted. Systems are also taught herein for accomplishing these tasks in several ways, namely:
1.through acquiring information from computer databases and other sources to organize and construct any number of Lists of Eligible Voters; and furthermore, Lists of Officials, and other data relevant to the Voting Session.
2. through a Paper Voting method employing the use of a carbonless copy paper MASTER Ballot which comprises of a unique, identifier; furthermore that this identifier be extremely difficult to guess, as Random Symbolic Identifier or some other repeatable pattern of unique identifiers; or a hybrid of random and fixed identifiers;
3. through the use of specially designed Security Elements for authentication, Limits of Use and other related data;
4. through the use of optical barcodes and other codes to facilitate computer processing;
5. through use of a Telephone Voting method;
6. through the use of an electronic facsimile (FAX) Voting method;
7. through the use of an Internet webpage Voting method;
8. through the use of an Internet email Voting method;
9. through the use of audio voting method;
10. through the use of a video voting method with optional audio;

However, the particular systems discussed herein are given as some of the illustrations of particular embodiments of the invention. Other embodiments of the invention are expected to employ differing degrees of automation in providing, validating, authenticating, recording, tallying, publishing, certifying recorded and tallied votes.

The systems taught and described herein are not intended to limit the application of the method claimed. The method of the invention must involve instrumentalities and combinations having different manifestations of representation, physical sizes and characteristics to suit the many corresponding physical limitations, abilities, and requirements that bear on a particular voting session or the available technology used to achieve some purpose for any voting session.

The spirit of this invention will be fulfilled as long as the principles of ensuring all Eligible Voters have anonymity when casting their initial ballots, and may anonymously verify or report errors regarding the record of their ballots, thus ensuring the election system provides the intended equality for each vote cast.

Accordingly, it is an object of the present invention to provide a voting method and system that allows one or more voters to completely verify the accurate recording, tally and publication of each vote on any Proposal or Candidate or any number of combinations of candidates and proposals;

It is a further object of the invention to provide a voting method and system that allows each Voter and Official to verify their votes on any Proposal or Candidate was correctly recorded, tallied and published. It is a further object of the invention to provide each voter with a private receipt ballot record of the voter's primary ballot vote.

It is a further object of the invention to provide a public post-polling record of all votes cast on a proposal or candidate. It is a further object of the invention to provide in a voting method and system, the capability for voters to use their private receipt ballot records of their cast primary ballot votes to verify or authorize correction of the public record of all ballots and votes cast.

It is a further object of the invention to provide in a voting system the capability for voters to use the verified or corrected public record of all votes cast to verify or authorize correction of the tallies or summaries of votes. It is a further object of the invention to provide vote verification and/or vote correction capabilities in a voting method or system that utilizes any physical, or, electronic, or, optical means of providing, receiving, recording validating, verifying, authenticating, tallying, summarizing, publishing and certifying: votes, ballots records, tallies, summaries or results.

It is a further object of the invention to provide in a voting system the capability for voters to use the records of all Eligible Voters to verify or authorize correction of their name and contact information to any list of Eligible Voters. It is a further object of the invention to provide vote verification and/or vote correction capabilities in a voting method or system that utilizes any physical, or, electronic, or, optical means of providing, receiving, recording validating, verifying, authenticating, tallying, summarizing, publishing and certifying any records, tallies, summaries or publications of any List of Eligible Voters. In addition to the foregoing, further, objects, features, and advantages of the present invention should become more readily apparent to those skilled in the art upon a reading of the following detailed description in conjunction with the drawings, wherein there are shown and illustrated as examples of embodiments of the invention.

It is evident that those skilled in the art may now make numerous other uses and modifications of and departures from the specific embodiments described herein without departing from the inventive concepts. Consequently, this invention is to be construed as embracing each novel feature or novel combination of novel features present in or possessed by the methods and techniques herein disclosed and is not to be limited by the spirit or scope of appended claims.

There are at least 20 (TWENTY) drawings for this invention.

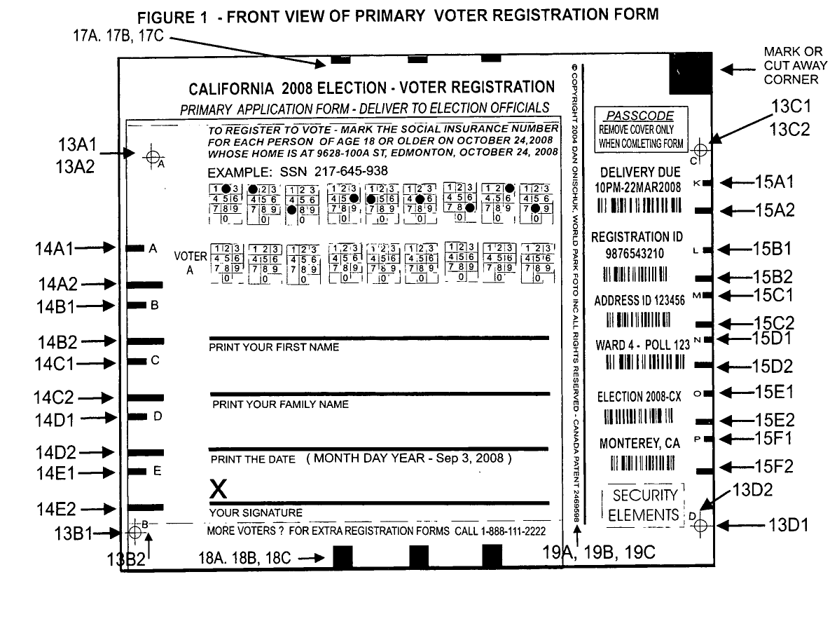

FIG. 1: a site plan view for the FRONT side of a first embodiment of a PRIMARY part of a Master Voter Registration form of the invention.

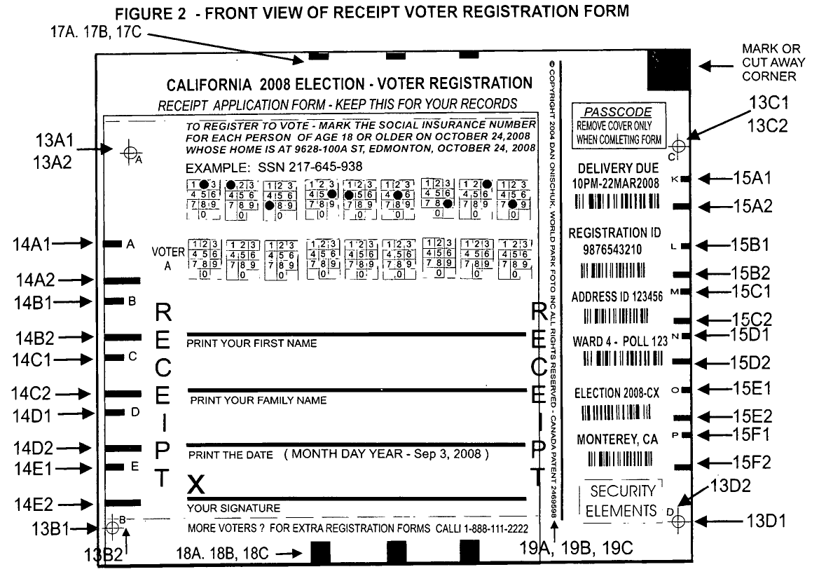

FIG. 2: a site plan view for the FRONT side of a first embodiment of a RECEIPT part of a Master Voter Registration form correlated to FIG. 1 of the invention.

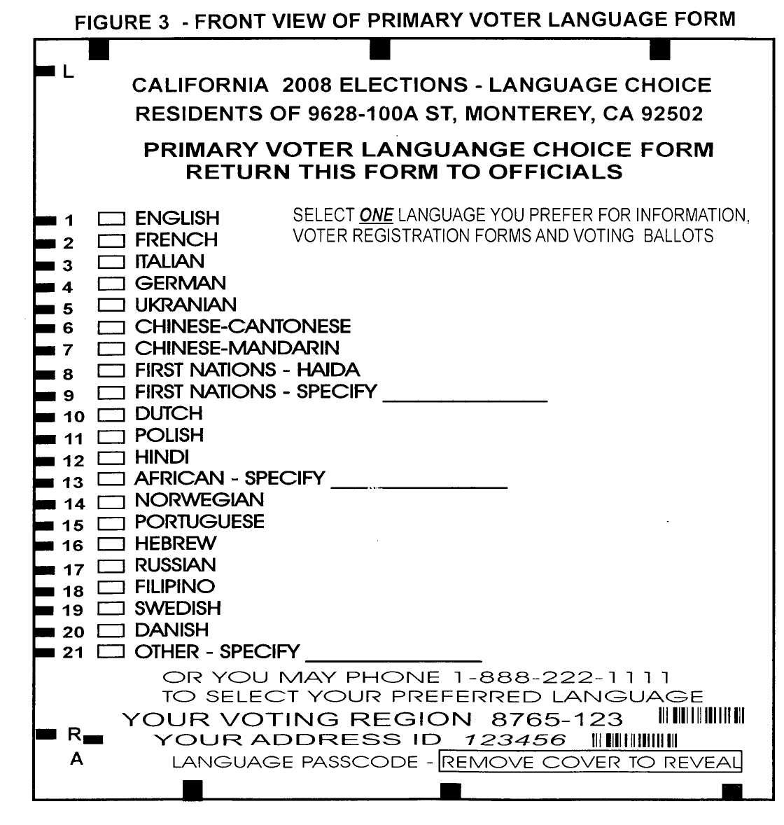

FIG. 3: a site of view for the FRONT side of a first embodiment of a PRIMARY part of the Master Voter Language Registration of the invention;

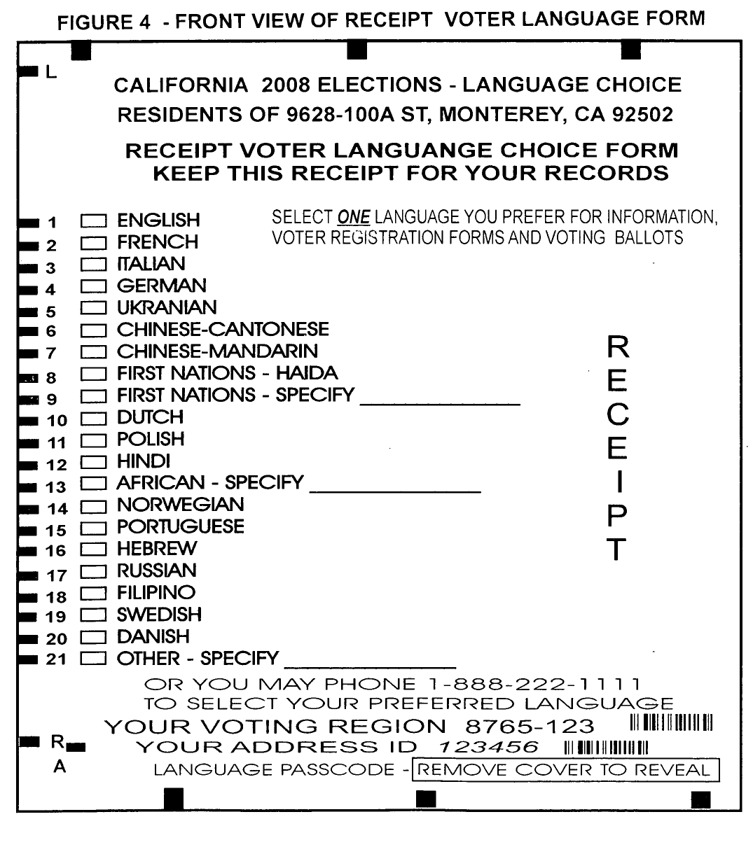

FIG. 4: a site of view for the FRONT side of a first embodiment of a RECEIPT part of the Master Voter Language Registration correlated to FIG. 3 of the invention;

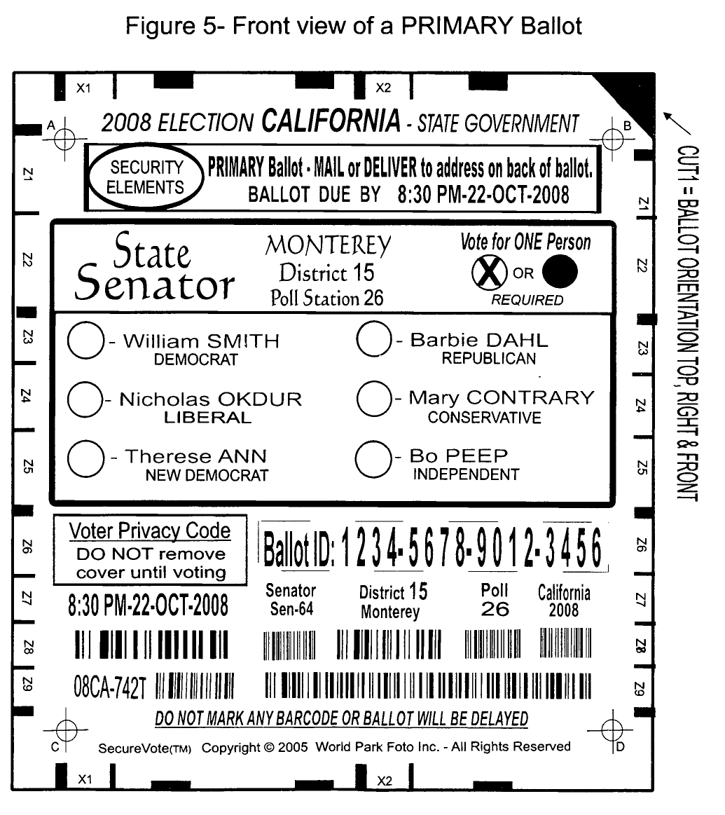

FIG. 5: a site plan view for the FRONT side of a first embodiment of a PRIMARY part of a Master Ballot of the invention.

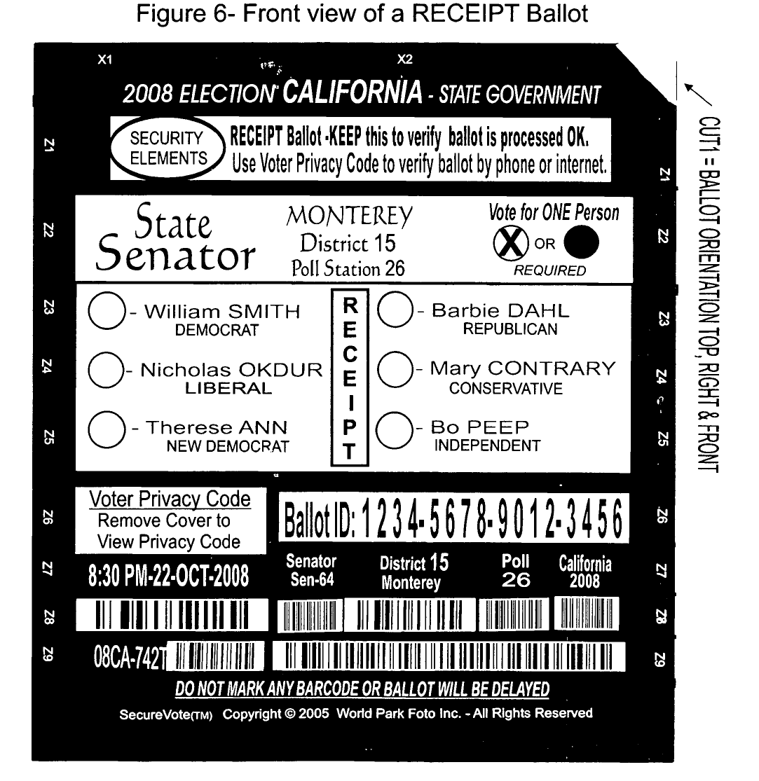

FIG. 6: a site plan view for the FRONT side of a first embodiment of a RECEIPT part of a Master Ballot correlated to FIG. 5 of the invention.

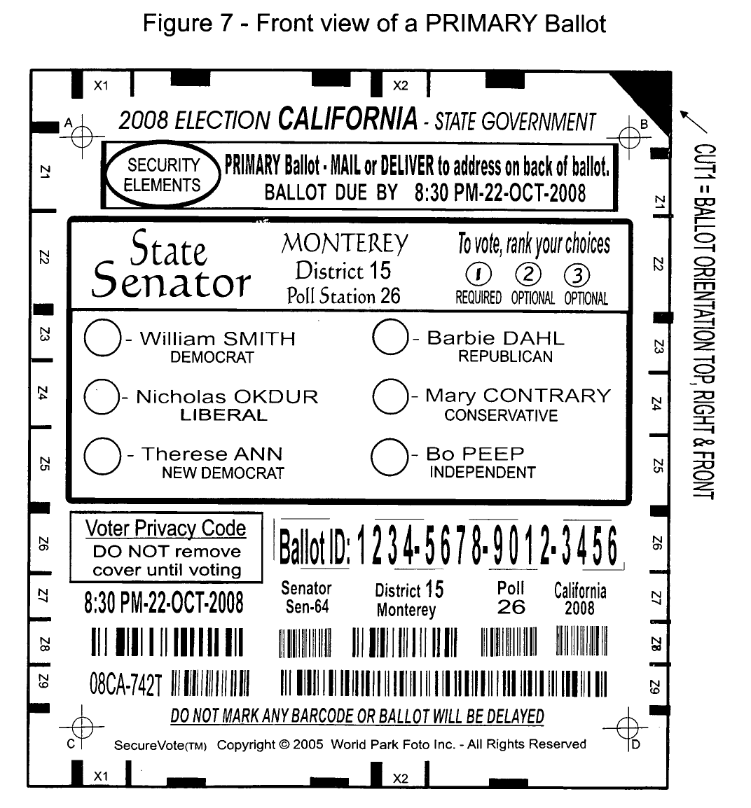

FIG. 7: a site plan view for the FRONT side of a second embodiment of a PRIMARY part of a Master Ballot of the invention;

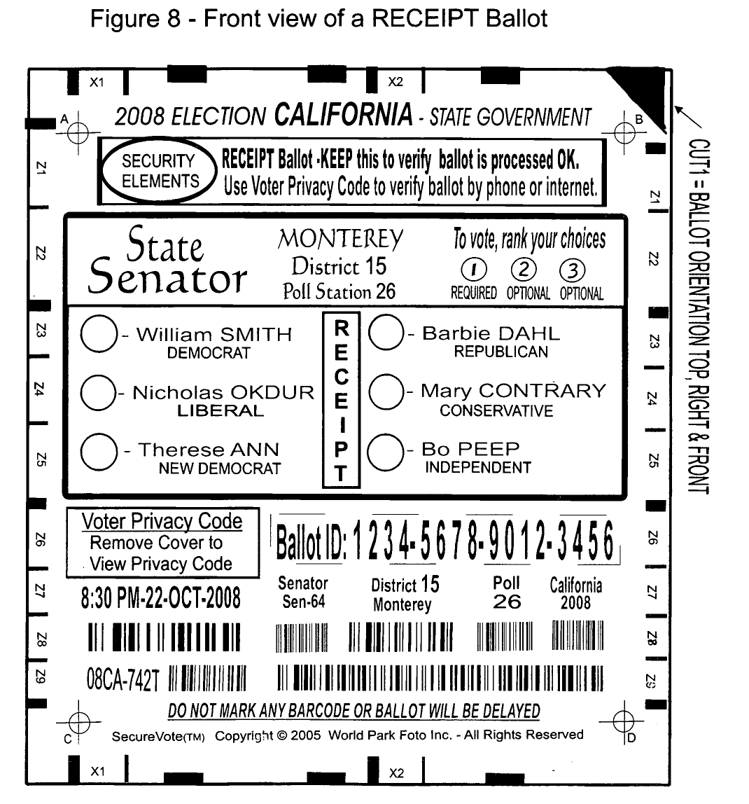

FIG. 8: a site plan view for the FRONT side of a second embodiment of a RECEIPT part of a Master Ballot correlated to FIG. 7 of the invention.

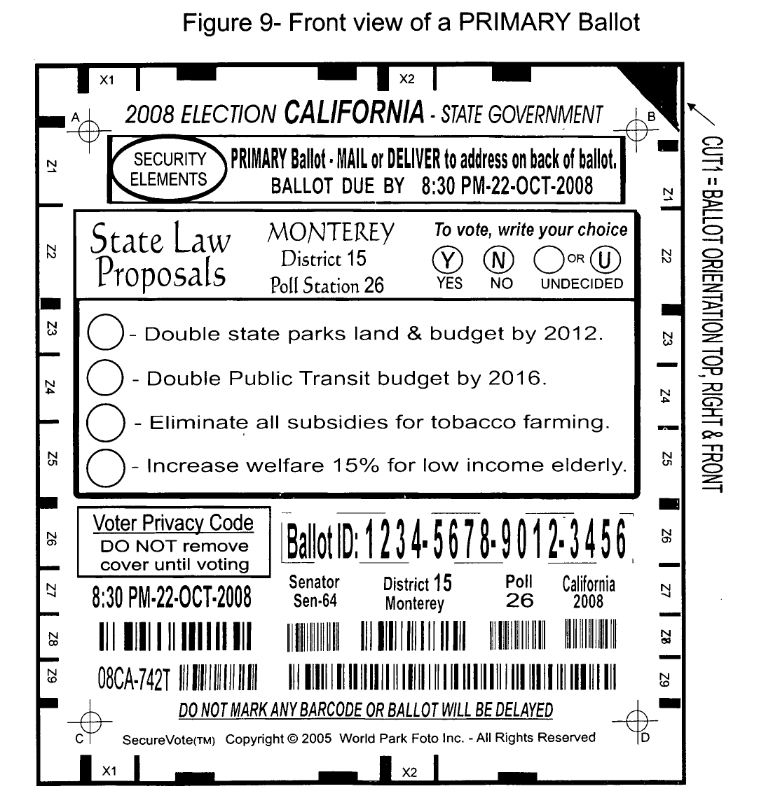

FIG. 9: a site plan view for the FRONT side of a third embodiment of a PRIMARY part of a Master Ballot of the invention;

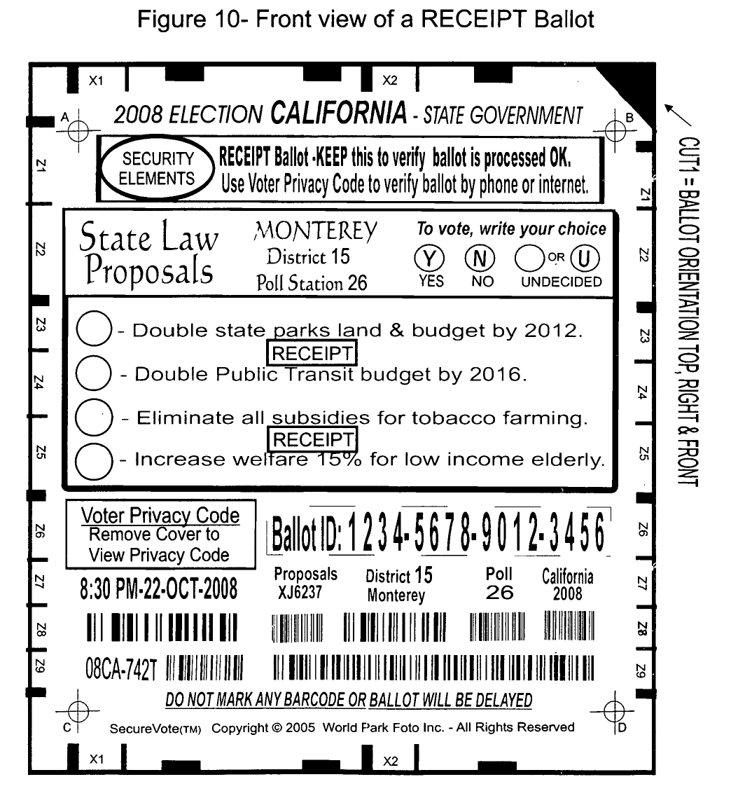

FIG. 10: a site plan view for the FRONT side of a third embodiment of a RECEIPT part of a Master Ballot correlated to FIG. 9 of the invention.

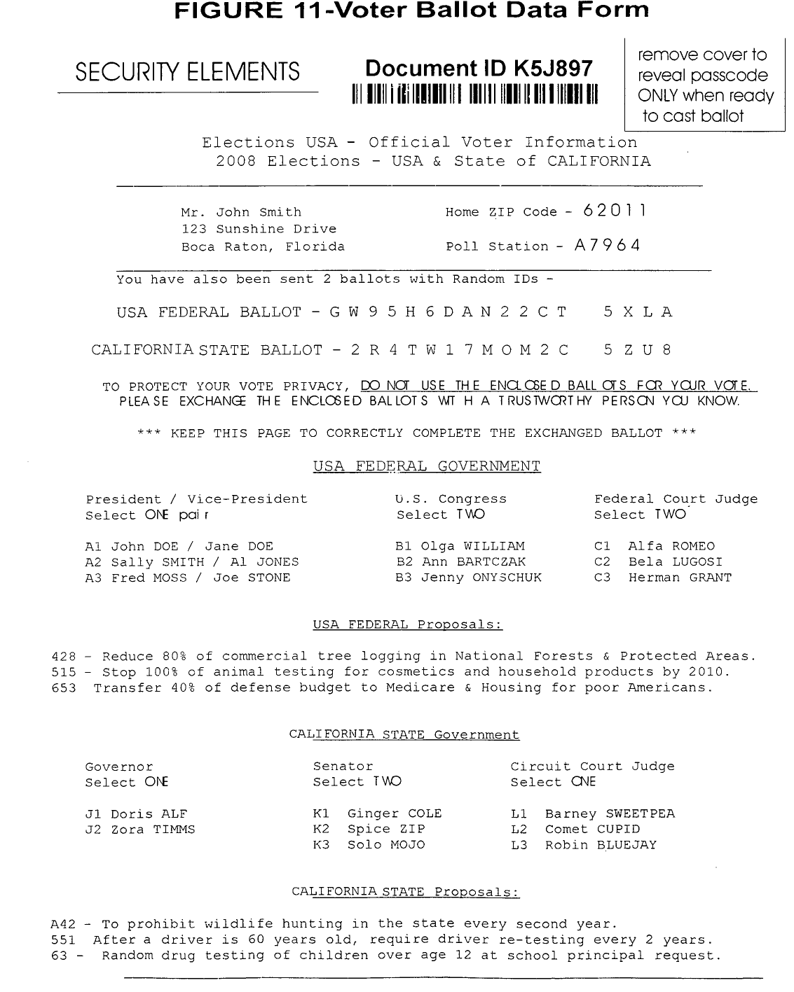

FIG. 11: is a site plan view of a first embodiment the Voter Ballot Data document of the invention.

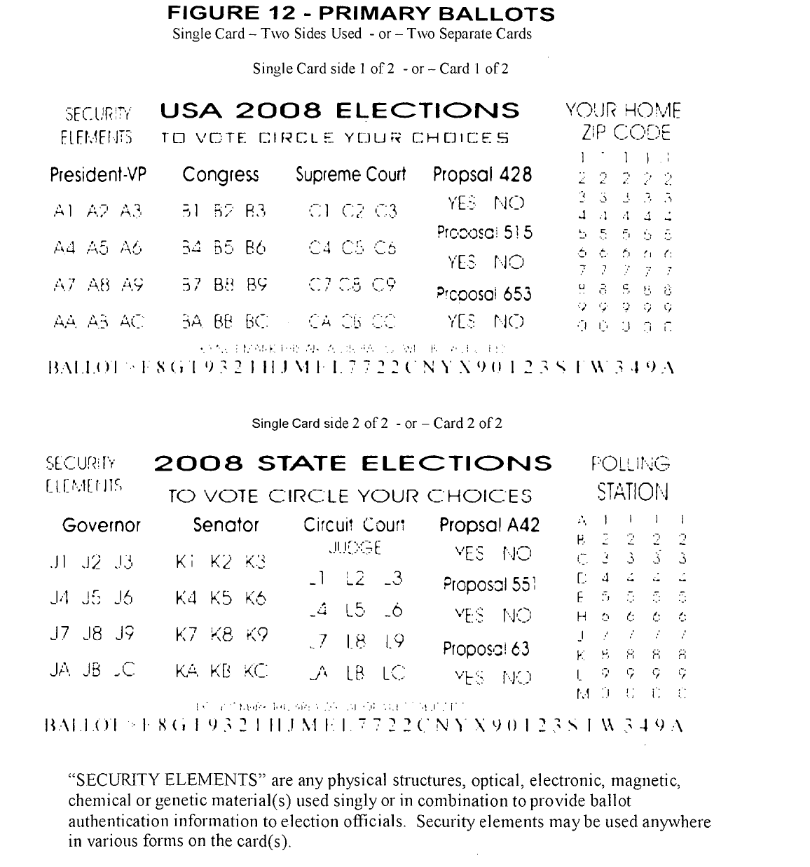

FIG. 12: a site plan view for the FRONT side of a fourth embodiment of a PRIMARY Ballot, correlated to FIG. 11 of the invention.

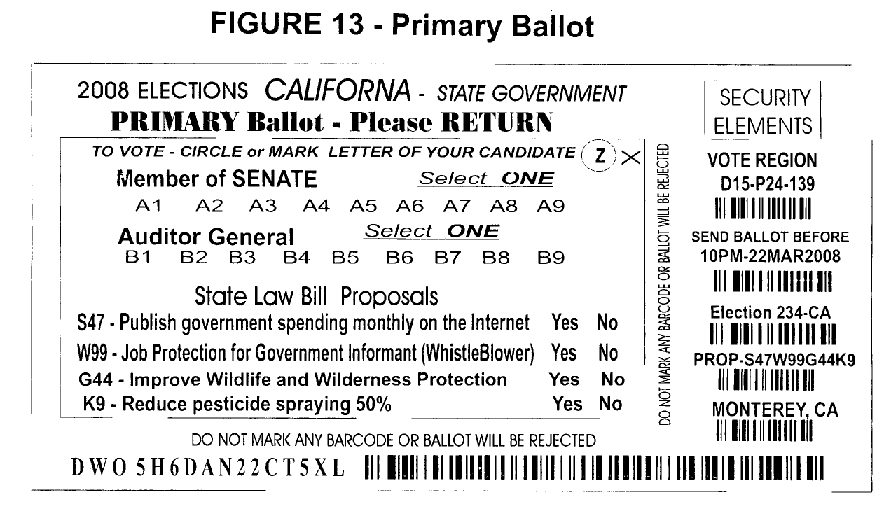

FIG. 13: a site plan view for the FRONT side of a fifth embodiment of a PRIMARY Ballot of the invention.

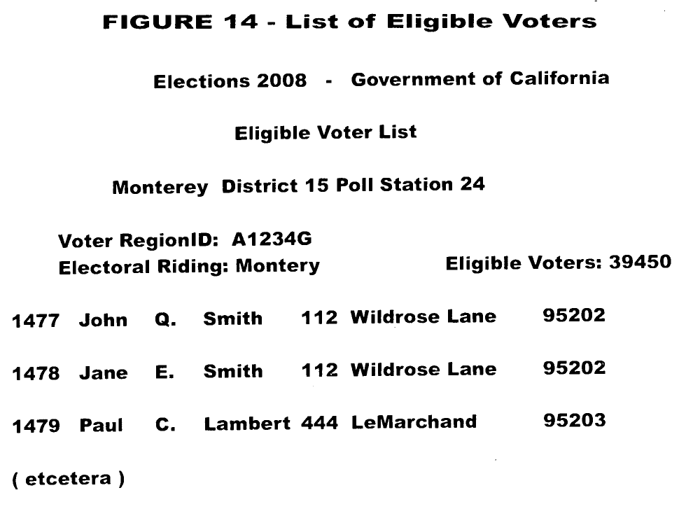

FIG. 14: is a site plan view of a first embodiment of a List of Eligible Voters document of the invention.

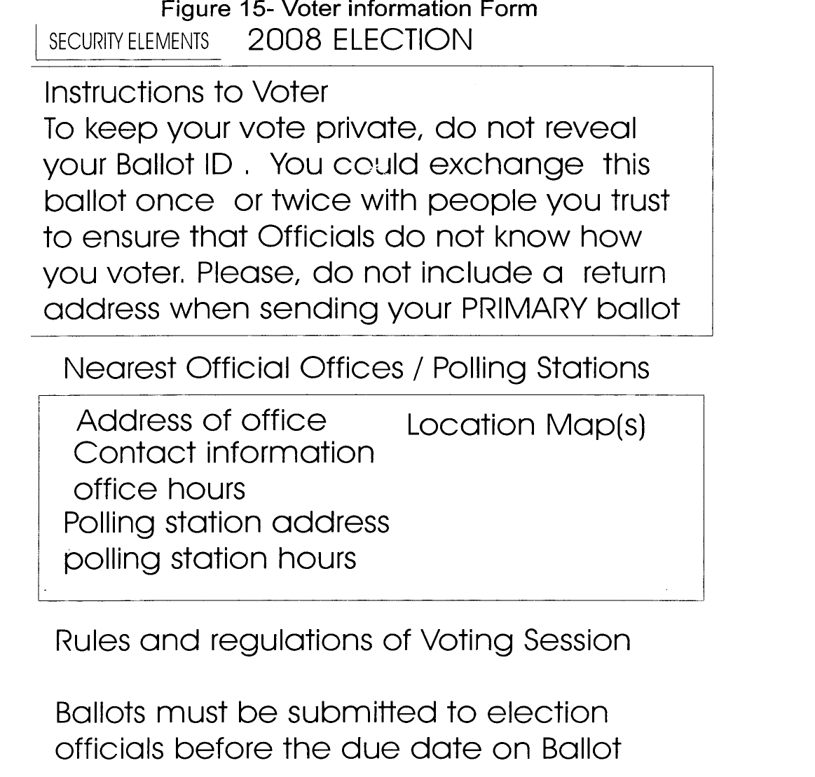

FIG. 15: is a site plan view of a first embodiment of a Voter Information Sheet document of the invention.

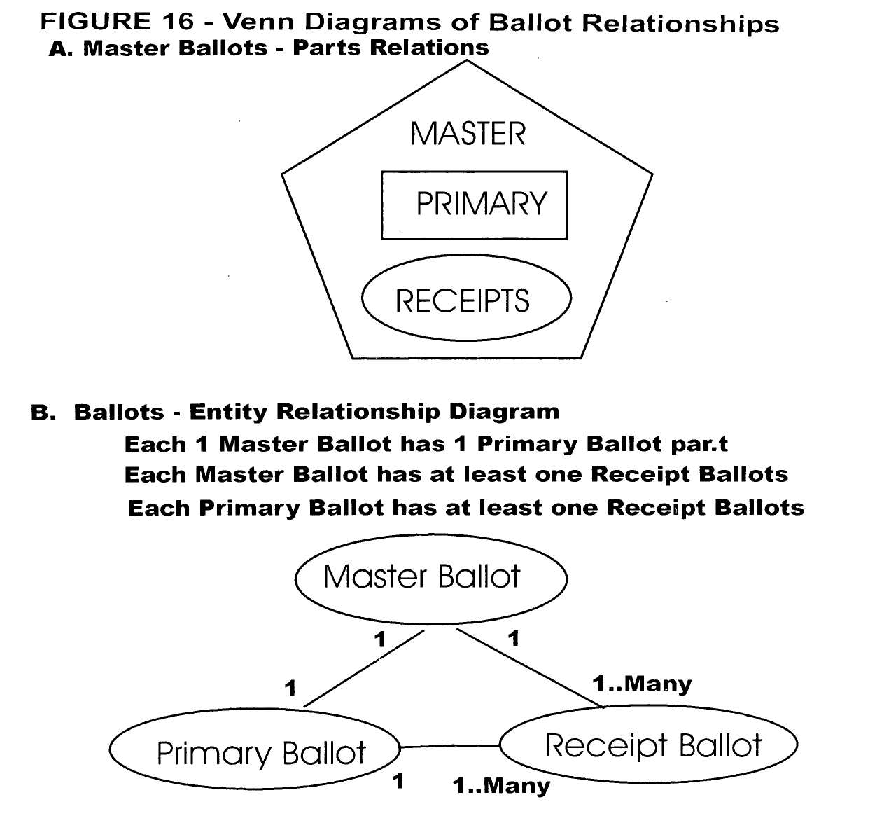

FIG. 16: a first embodiment of (A.) a Venn Diagram describing the Set of a Master Ballot and Constituent Parts (B.) Entity Relationship Diagram of a Master Ballot and Constituent Parts document of the invention.

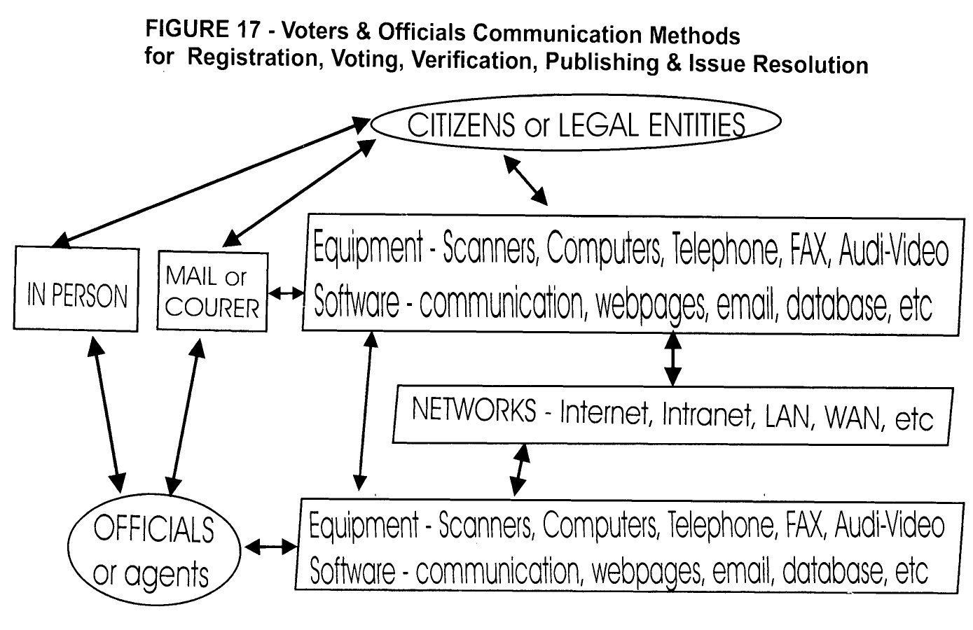

FIG. 17: a first embodiment of a data flow diagram of Methods of Ballot Delivery or Communication document of the invention.

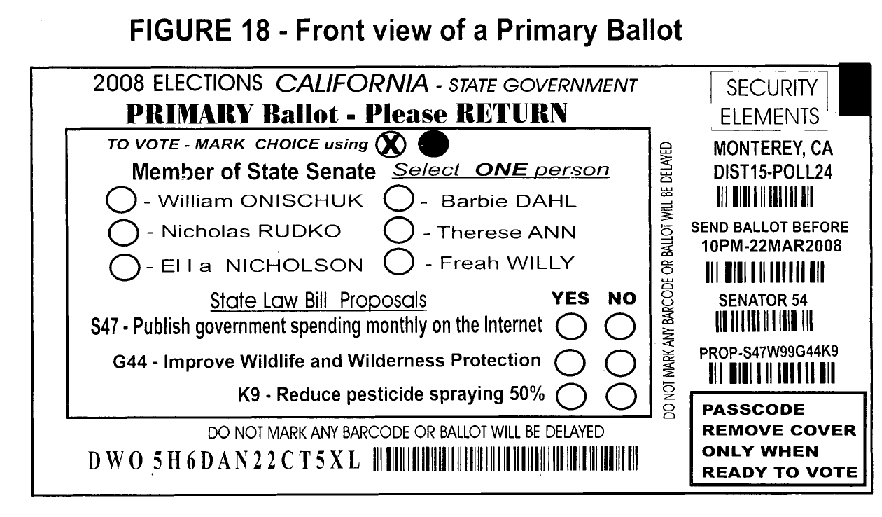

FIG. 18: a site plan view for the FRONT side of a sixth embodiment of a PRIMARY Ballot of the invention.

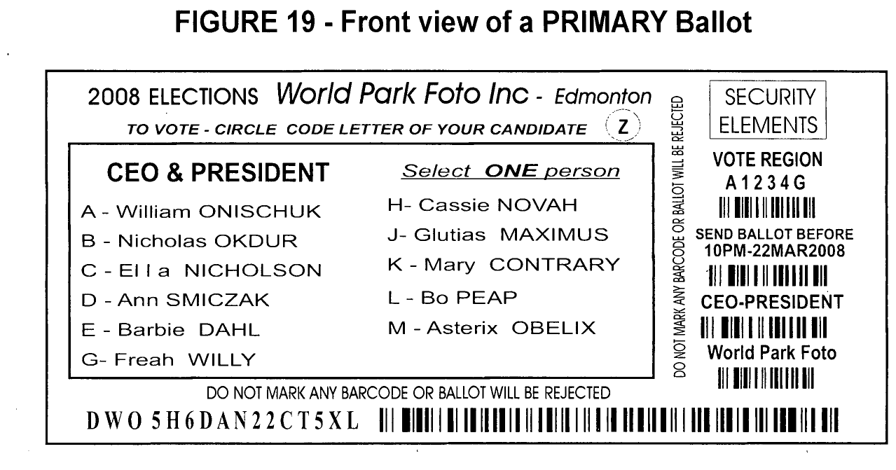

FIG. 19: a site plan view for the FRONT side of a seventh embodiment of a PRIMARY Ballot of the invention.

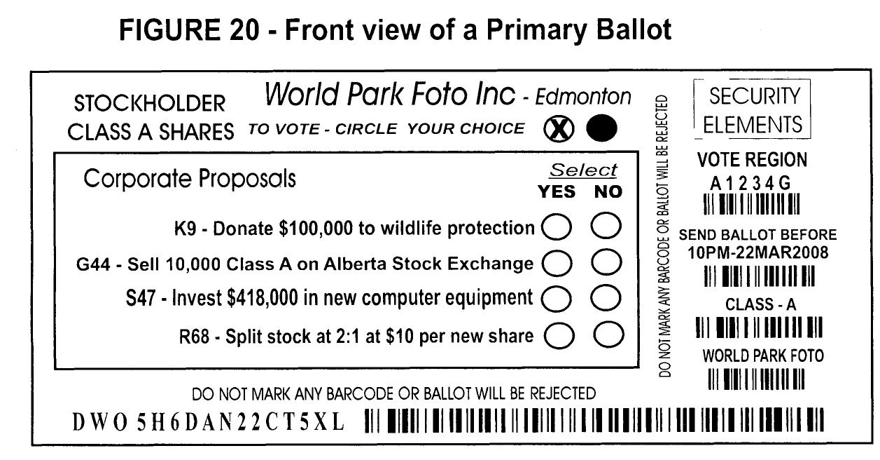

FIG. 20: a site plan view for the FRONT side of an eighth embodiment of a PRIMARY Ballot of the invention.

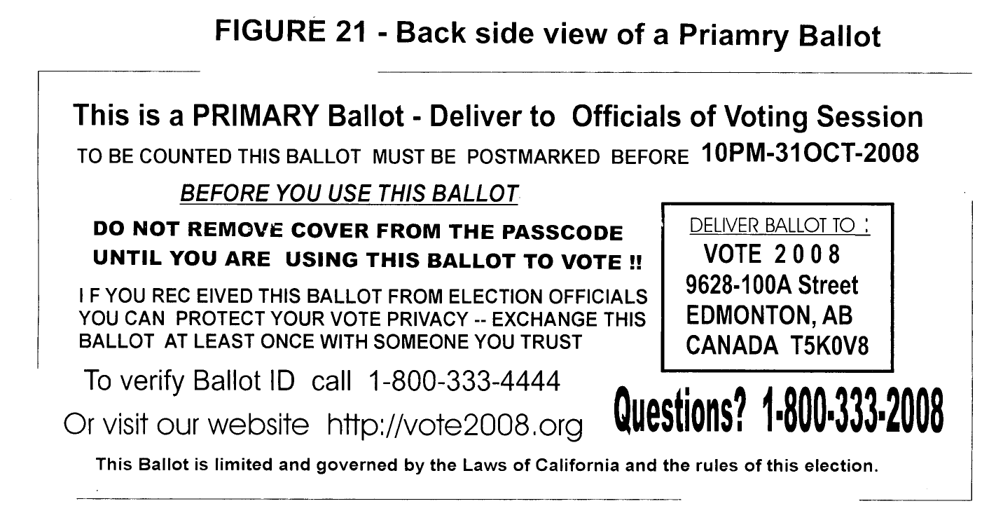

FIG. 21: a site plan view for the BACK side of a first embodiment of a PRIMARY Ballot, correlated to FIGS. 5,7,9,12, 13,18,19,20 of this invention; and with further modification, FIG. 21 may then be correlated to FIG. 1 for Voter Registration forms, or, FIG. 3 for Voter Language forms of this invention;

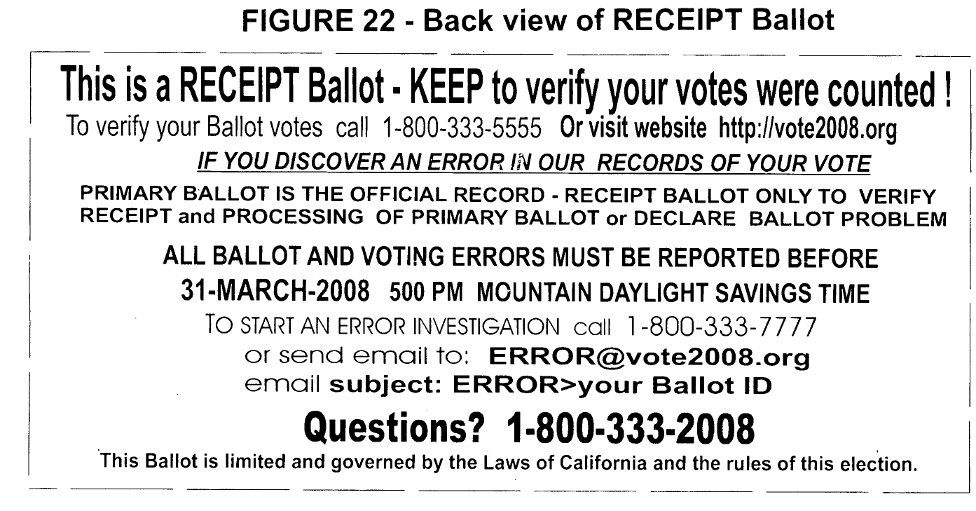

FIG. 22: a site plan view for the BACK side of a first embodiment of a RECEIPT Ballot, correlated to FIGS. 6,8,10 of this invention; and with further modification, FIG. 22 may then be correlated to FIG. 2 for Voter Registration forms, or, FIG. 4 for Voter Language forms of this invention;

### DETAILED DESCRIPTION OF INVENTION

### DEFINITIONS OF TERMS

Official, or, Officials—refers to any number and any combination of: persons, devices, computer systems or communication networks appointed by the Hosts of the Voting Session to participate in at least one role or function to facilitate any aspect of the Voting Session;

Voter, or, Voters, Eligible Voter, or, Eligible Voters—refers to any number of, persons, or, business entities, or any group of people or business entities, that are, or may be, entitled to participate in the Voting Session for the purpose of casting any number of ballots to select any number of candidates or proposals;

Voting Session—refers to a process or series of steps and methods for the at least one purpose: to elect at least one candidate, or, express at least one opinion regarding at least one proposal, or any combination of electing at least one candidate and expressing at least one opinion for at least one proposal;

Voting Region is used to describe the Scope of a Voting Session—refer to Entity-Relation Diagrams of FIGS. 54 to 60, and FIGS. 69 to 72.

Voting Region is also used to refer to a variable group of attributes—Province or State, Municipality, Zone, Poll Station, Postal or Zip Code. The attributes are used for data storage, and may also be components of the Voting REGION, depending on the Scope of the Voting SESSION.

Any number of Voting Region attributes may be visible on Ballots, Reports, Calculations, Tallies, Summaries, etcetera as determined by Officials to meet the needs of a particular Voting Session. (Refer FIGS. 61,73, 74, 75 and Disclosure Section 8.h.1.)

Preamble

as the steps, means methods and processes described involve people and devices that are not perfect in design, function or operation, all aspects of this invention shall also include any steps, means, methods and processes of monitoring, acquiring, detecting, receiving, transmitting, verifying or correcting of any compromises, errors, duplicate data; and furthermore, any steps, means, methods and processes of monitoring, acquiring, detecting, receiving, transmitting, verifying the effects of any corrections or other actions taken;

2. All methods within the broad scope of data processing tasks may be applied to this invention; in particular this invention includes the means and methods of acquiring data from any remote or local data source, or any ballots of any type that conforms to the specifications of the Voting Session; furthermore these methods include:

2.a. The steps of locating, detecting, reading, receiving, interpreting, translating, correcting, and transmitting any number of, and any combination of: symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing and any other physical structures associated directly with a ballot or a plurality of Master Ballots, Primary Ballots, Receipt Ballots, Voter Registration Forms, or Voter Registration Receipts or any other related documents;

2.b. whereby the tasks of locating, reading, receiving, detecting, translating, correcting, interpreting and transmitting are performed by any combination of:

2.b.1. at least one Official person;

2.b.2. any number of data acquisition devices;

2.b.3. any number of electronic, optical or biological computing devices;

12.b.4. any number of communication networks;

2.b.5 any number of other man-made device or plurality of devices;

2.c. the methods of transmitting data to, and receiving data from, any number of humans, computers, devices, telephones, the Internet or any other communications networks; including the methods of translating human and device readable codes to modes, protocols or methods of communication and transmission;

2.d. the methods of locating, receiving, detecting, interpreting, translating, reporting, and transmitting error free data, and the further steps of locating, receiving, detecting, interpreting, translating, reporting transmitting, and correcting compromised data, erroneous data, duplicate data or duplicate transmissions;

### DISCLOSURE OF THE INVENTION

The methods and steps involved in the assembly of a List of Eligible Voters is unique and the first of many improvements to existing patents within this scope of invention.

1.a. an initial assessment is made to define the required tasks and estimate the labor time required to complete the required tasks to complete the Official Voting Session in the time allotted, and to justify the acquisition of materials, devices and people to enable completion of the Voting Session in a timely manner;

1.b. people, computers, devices, software programs, and communication systems are acquired and developed to complete at least the required tasks of the Official Voting Session;

1.c. a determination is made regarding the number of Potential Voters that could participate in the Voting Session, using data from reliable sources (such as census population data, immigration data, social security numbers or tax data for governments; stockholders or employee data for corporations or businesses; membership data for groups or organizations);

1.d. Officials enquire about remote sources of information that could be used to identify Potential Voters or Eligible Voters, then contact owners of each selected remote data source to obtain agreements, access permissions and methods. A unique source identifier (SID) is assigned for each remote source that permission is obtained.

1.e. for a remote source of records to be accepted, it undergoes a preliminary inspection to assess whether it will meet standards for acceptable regarding the relative age of the data, reliability, consistency of data among records, or other quality control methods;

1.f. remote sources of data the DO NOT pass the preliminary inspection requirements are ignored or designated for further investigation at some later time and date;

For remote sources of data that DO meet First Inspection requirements:

1.g. to determine which people or businesses are eligible to vote, Official people, or, Official computers running software programs designed to determine who are Eligible Voters, access computer databases such as those affiliated with sources such as census population data, immigration data, social security and tax data for governments; stockholders or employee data for corporations or businesses; memberships data for groups or organizations, and other information sources (e.g. paper records, microfilm) which contain data about people or business entities;

1.h. to accurately determine and keep a verifiable record of which people or business entities are eligible to vote, selected remote source records or parts of remote source records containing data about people or business entities are retrieved by Official people, or, Official computers running software programs;

1.i. remote source records that contain sufficient data to identify and fulfill the requirements for an Eligible Voter record, are duplicated; and the duplicate copy is verified, then transferred to the record storage facilities and computer data storage systems of the Officials of the Voting Session; furthermore, each of the records transferred is assigned a unique Potential Voter Identifier (PVID), and is marked so as to describe the information as being from a remote source, the remote source identifier (SID), as well as the date, time of transfer, and which Officals authorized the transfer and acceptance of data;

1.j. remote source records that are missing data are then marked as; Research; Voter for further investigation, and each Research Voter record is assigned a unique identifier (RVID); and each Research Voter record is kept separate from every List of Eligible Voters;

1.k. Officials are assigned to investigate, update and report on each Research Voter record;

1.l. when each Research Voter record is updated, it is also checked to determine whether it contains sufficient information to satisfy the requirements of data acceptance standards of an Eligible Voter; if so, then it is copied, the original Research Voter record status is marked RESEARCH-ELIGIBLE, the copy record is marked as Eligible Voter, then the copy record is added to the group of Eligible Voter records; and assigned a unique Eligible Voter Identifier (EVID), while also retaining the RVID identifier to so as to enable auditing;

1.m. Official people or Official computers running software programs, determine which Research Voter records and which Potential Voter records meet the criteria of the Voting Session to be assigned the designation of Eligible Voter; furthermore, each voter meeting the criteria are designated as Eligible Voter records and are assigned a unique Eligible Voter identifier;

2.a.1. Official people or Official computers running software programs, assemble and organize at least one List of Eligible Voters based on Voting Session criteria, comprised of: at least, the names of the voter; and may also include their last known physical address for mail delivery; electronic address or any other method for delivery (such as a private fax machine number, or, forwarding contact address); furthermore, each List of Eligible Voters is assigned an Eligible Voter List Identifier (LEVID); for example, each List of Eligible Voters may be organized by any number of applicable sub-groups of political areas, geographic areas (e.g. electoral boundaries) or people (e.g. citizens of a country, membership dues paid, stockholders having voting shares) for the Voting Session.

2.a.2. identical, duplicated records of Eligible Voters found in any one, or existing within several, Lists of Eligible Voters, are removed so that only one instance of a unique Voter remains, so as to prevent multiple ballots being delivered to a single voter;

2.a.3. if the rules of the Voting Session, or, any group of people or business entities, or members of a business allow multiple listing of a unique Eligible Voter, then that instance is also an instance or part of this invention; and the preceding step 2.a.2. will be done in another manner so as to accommodate the integrity of the Voting Session, for any group of people or business entities, or any members of a group or business.

2.a.4. Officials publish each List of Eligible Voters—for example, on Internet website pages;

2.a.5. Officials advertise the location and methods of accessing each List of Eligible Voters; this step may include sending confirmation notices to each Eligible Voter on each List of Eligible Voters;

2.a.6. Officials provide means and opportunities to all Potential Voters and Eligible Voters to verify or amend each List of Eligible Voters;

2.a.7. Officials provide means and opportunities to any subset of any, or, all Potential Voters, Research Voters, and Eligible Voters to contact Officials to amend the List of Eligible Voters—for example, by telephone, the Internet, by letter, by facsimile (fax) transmission, or in person.

2.a.8. Officials investigate each Potential Voter, Research Voter and Eligible Voter request for amendment and report the findings to Officials and the voter;

2.a.9. Officials amend any number of Lists of Eligible Voters;

2.a.10. Officials and the voters verifies the amendments were completed and accurate;

3.a. Official people or Official computers run software programs to design, and produce any form of specially designed MASTER Ballots; using the official language of the Voting Session; or, the predetermined, or, selected, preferred language of the Eligible Voter;

3.b. Official people or Official computers run software programs to print or generate any form of representation, of specially designed MASTER Ballots; using the official language of the Voting Session; or, the predetermined, or, selected language of the Eligible Voter;

3.c. the number of MASTER Ballots printed or generated is determined by the number of Eligible Voters plus an estimated number to accommodate Lost, Stolen, Damaged, or Spoiled Ballots, and an estimated number of additions to every List of Eligible Voters used for the particular Voting Session;

3.d. each MASTER Ballot is tested to be both VALID and AUTHENTIC;

3.e. for each MASTER Ballot is passing tests to be AUTHENTIC and VALID according to step 3.d.; the further step of designating the Master Ballot, and its constituent parts, to having a Verification Status identifier designated as CERTIFIED;

3.f. the Delivery Status identifier of each MASTER Ballot of step 3.e. is designated as READY;

3.g. the Activity Status identifier of each MASTER Ballot of step 3.f. is now set to be DORMANT;

3.g. the number of MASTER Ballots printed or generated is very carefully controlled, monitored and regulated by Officials of the Voting Session;

3.h. Official people or Official computers run software programs to arrange delivery of any number of MASTER Ballots to each Eligible Voter on every Eligible Voter List;

3.i. as each MASTER Ballot is processed through the final steps for delivery, the value of the Delivery Status identifier changes from READY to DELIVERED;

3.j. as each MASTER Ballot is processed through the final steps for delivery, the value of the Activity Status identifier changes from DORMANT to ACTIVE;

4.b. Officials prepare and publish any number of Voter Data Sheets which describes any combination of candidates, proposals, voting session rules, voting instructions, polling station maps, etc. This may also be repeated on the Officials website.

4.c.Eligible Voters receive at least one MASTER Ballot from Officials or appointees;

4.d Eligible Voters receive any number of optional, Voter Data Sheets;

4.e. Eligible Voters receive any number of optional, PRIMARY Ballot return envelopes;

5.a. Any Eligible Voter or Official may obtain a replacement MASTER ballot in exchange for any DAMAGED or SPOILED ballot which has an Activity Status of ACTIVE, and a Verification Status of CERTIFIED;

5.a.1. any number of Voters (Applicants) or Officials (Applicants) deliver any number of MASTER, PRIMARY, PHONE, or, INTERNET Ballots to any number of Officials;

5.a.2 Officials receive any number of Ballots from Applicants;

5.a.3 Officials record at least the names and address of each Applicant requesting Ballot Replacement; as well as the date and time of filing the request for replacement; as well as additional identification such as social security number, drivers license number, passport identifier, may also be recorded;

5.a.4.1. if the Applicant claims to be an Eligible Voter, Officials search each current List of Eligible Voters for that Voting Session until a determination can be made;

5.a.4.2. if the Applicant claims to be an Official of the current Voting Session, other Officials search each List of Officials for that Voting Session until a determination can be made;

5.a.5.a. Officials accept or reject each received ballot based on the findings of tests applied to confirm the authenticity and validity of each ballot; for example, by verifying Security Element of the Ballot; verifying the Random Symbolic Identifier is Officially valid; verifying Limits of Use;(Recall the Preamble regarding data acquisition, transmission, etc.)

5.a.5.b. Officials may further accept or reject each received ballot based on the Activity Status attribute of the ballot, whereby the Official decision to accept is for any ACTIVE ballots;

5.a.6. Providing the Applicant, Affidavit, and Ballot submitted are all valid, the ballot receiving Officials cancels the correlated ballots (for example by referring to the Ballot Random Symbolic Identifier), and records the relevant details of each ballot cancellation;

5.a.7. Officials amend all Voting Session records to indicate the ballot Activity Status attribute is designated as CANCELLED for all ballots having the same Random Symbolic Identifier (RSID);

5.a.8. Officials verify the SPOILED or DAMAGED Ballot Activity Status attribute is designated as CANCELLED, on all Voting Session records.

5.a.9.a. Officials select one MASTER Ballot, designated as a REPLACEMENT Ballot, for each Ballot that was CANCELLED; whereby:

5.a.9.a.1. each REPLACEMENT Ballot is identical to the CANCELLED ballot, except for at least one Random Symbolic Identifier of the REPLACEMENT Ballot being distinctly different from every Random Symbolic Identifier of the CANCELLED Ballot;

5.a.9.a.2. each REPLACEMENT Ballot is tested to be both VALID and AUTHENTIC;

5.a.9.a.3. each REPLACEMENT Ballot passing tests of step 5.a.9.a.2 has a Verfication Status designated as CERTIFIED;

5.a.9.a.4. REPLACEMENT Ballot Activity status is designated as ACTIVE;

5.a.10. at least one Official delivering, or arranging the delivery of, a correlated number of REPLACEMENT Ballots to each Applicant; whereupon the Ballot is now designated as a MASTER ballot; furthermore, the Delivery Status attribute of each delivered REPLACEMENT Ballot becomes DELIVERED;

5.a.11. any number of Officials record the quantity and type of REPLACEMENT-MASTER Ballots delivered to every Applicant;

5.a.12. any number of Applicants receive any number of uniquely different REPLACEMENT-MASTER ballots of the same type submitted for replacement;

5.b. Any Eligible Voter or Official may obtain a replacement MASTER ballot in exchange for any LOST or STOLEN ballot which has an Activity Status of ACTIVE, and a Verification Status of CERTIFIED;

5.b.1 any number of Voters (Applicants) or Officials (Applicants) deliver any number of MASTER, PRIMARY, PHONE, or, INTERNET Ballots to any number of Officials;

5.b.2. Officials receive any number of Ballots from Applicants;

5.b.3. Officials record at least the names and address of each Applicant requesting Ballot Replacement; as well as the date and time of filing the Affidavit along with additional identification such as social security number, drivers license number, passport identifier, may also be recorded;

5.b.4. any number of Officials provides any number of Applicants with at least one Affidavit form for the purpose of declaring a Ballot of claim 11.(a.) to be either LOST, or, STOLEN;

5.b.5. each Applicant completes the Affidavit of step 5.b.4. whereby

5.b.5.a. each Applicant provides their full legal name with the Affidavit;

5.b.5.b. each Applicant provides their address, when applicable, with their Affidavit;

5.b.5.c. each Applicant provides at least one form of Voter identification to verify their identity according to the Affidavit;

5.b.5.d. each Applicant signs the Affidavit, physically, electronically, or by any other acceptable means according to the Rules of the Voting Session;

5.b.6.a. each Applicant delivers, or arranges for delivery of their Affidavit to Officials;

5.b.6.b. any number of Officials receives any number of Affidavits and identification;

5.b.7.a. if the Applicant claims to be an Eligible Voter, Officials determine whether the Applicant is valid by searching every List of Eligible Voters for that Voting Session until a determination can be made;

5.b.7.b. if the Applicant claims to be an Official of the current Voting Session, other Officials determine whether the Applicant is valid by searching every List of Officials for that Voting Session until a determination can be made;

5.b.7.c. Officials may further accept or reject each received ballot based on the Activity Status attribute of the ballot, whereby the Official decision to accept is for any ACTIVE ballots;

5.b.8. any number of Officials, computers, optical or electronic devices, or humans accepts or rejects all other information provided for each Applicant, Affidavit or Ballot; (Recall the Preamble regarding data acquisition, transmission, etc.)

5.b.9. for each valid Applicant whose Affidavit that has been sufficiently verified, at least one Official amends the Voting Session computer records to CANCEL each LOST or STOLEN Ballot that was previously delivered to the Applicant;

5.b.10. at least one Official verifies that each LOST or STOLEN Ballot according to the preceding steps, is designated as CANCELLED on all Voting Session records; whereby the Activity Status attribute for each CANCELLED ballot record is set to CANCELLED;

5.b.11. at least one Official replaces or arranges to replace each LOST or STOLEN ballot, comprising of at least the steps whereby:

5.b.11.a. selecting one MASTER Ballot designated as a REPLACEMENT Ballot for each Ballot that was CANCELLED;

5.b.11.b. each REPLACEMENT Ballot is identical to the CANCELLED ballot, except for at least one Random Symbolic Identifier of the REPLACEMENT Ballot being different from every Random Symbolic Identifier of the CANCELLED Ballot;

5.b.11.c. each REPLACEMENT Ballot of claim is tested to be both VALID and AUTHENTIC;

5.b.11.d. each REPLACEMENT Ballot passing tests of step 5.b.11.c. has a Verification Status designated as CERTIFIED;

5.b.11.e. the REPLACEMENT Ballot of 5.b.11.d. Activity status is set to ACTIVE;

5.b.11.f. for each verified Applicant whose Affidavit was also verified, at least one Official delivers, or arranges for the delivery of, at least one, REPLACEMENT Ballot to the Applicant that completed the Affidavit;

5.b.11.g. at least one Official delivers, or arranges the delivery of, any number of REPLACEMENT Ballots; whereupon delivery, the Ballot is now designated as a MASTER ballot; furthermore, the Delivery Status attribute of each delivered REPLACEMENT Ballot becomes DELIVERED;

5.a.11.h. any number of Officials record the quantity and type of REPLACEMENT-MASTER Ballots delivered to every Applicant;

5.b.12. any number of Applicants receive any number of unique, different REPLACEMENT-MASTER ballots of the same type submitted for replacement;

6. MASTER Ballot Exchange—this method is unique among registered US Patents, and provides a significant improvement in the arts pertinent to this scope of invention.

6.a. Eligible Voters are entitled to exchange with someone they trust, any number of MASTER Ballots they possess for identical MASTER ballots that are authentic and valid for use as per the Limits of Use. Voters can authenticate the ballot in person, by telephone or Internet by verifying the Random Symbolic Identifier. Security Elements may also be used to determine whether the ballot is a forgery of truly authentic ballot.

6.b. Like currency, Ballots can be used by anyone—to protect privacy, Voters are instructed to swap the ballot the Voter received, at least once, with someone they trust within the geographic-political boundary of the Voting Session. This random, private ballot exchange decouples the Ballot recipient from the Eligible Voter List that was used to deliver the unique ballot RSID to a specific person and address. This can be done a few times to increase the anonymity of the Voter. Furthermore, the privacy of the Voter is still enabled somewhat even if a Voter does not exchange MASTER Ballots, as the Voting Session Officials likely have no easy method to determine whether or not any MASTER Ballot was exchanged before being returned to them for tallying.

7.a. Each MASTER Ballot has two parts—a PRIMARY Ballot and at least one RECEIPT Ballot (refer FIG. 55—A. Entity Relation Diagram describing Master Ballot and constituent parts)

7.b.1. Each MASTER, PRIMARY and RECEIPT Ballot has at least one status attribute each attribute remains static in value until redefined any number of times by Officials;

7.b.2. The paper version of a MASTER, PRIMARY, or RECEIPT Ballot shall include alignment marks and indices for orientation of optical, magnetic, electronic scanning device(s) so as to facilitate the accurate scanning of data on any reasonable ballot.

7.b.3. Each part of the MASTER Ballot, both the PRIMARY Ballot and any number of RECEIPT Ballots, share an identical, unique group of symbols as a correlating identifier. A unique feature of this invention is a Random Symbolic Identifier (RSID) as being the recommended unique correlating identifier, discussed in 8.c.3.

7.c. 1. the second ballot part of the MASTER Ballot is referred to as a RECEIPT Ballot; a unique feature of this invention is that each RECEIPT Ballot is manufactured so as to be easily and readily distinguishable from the PRIMARY Ballot, to the unaided human eye using any combination of methods:

7.c.1.a. additional markings not found on the PRIMARY Ballot;

7.c.1.b. different color than the color used for the PRIMARY Ballot;

7.c.1.c. different texture of material from that used for PRIMARY Ballot;

7.c.1.d. different physical, electronic, electromagnetic, or optical representation, or any other form of representation that differs from that which is used to manufacture the PRIMARY Ballot, which may include any combination of: printed symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing and any other physical structures associated directly with the RECEIPT Ballot so as to distinguish the RECEIPT Ballot from the correlated PRIMARY Ballot;

8. To understand the PRIMARY Ballot part of the Master Ballot referred to in 7.a., 7.b. refer to figure X (plan for the FRONT side of a first embodiment of a Primary Ballot of the invention).

8.a. ballot header portion—this portion improves the invention of Kargel by providing information to enable the voter to independently make clearly informed decisions regarding the ballot by providing information to the voter: as to the source of the ballot (figure X item 1a—ballot source); defining the scope of the ballot application (figure X item 1b—ballot purpose); clearly identifying the type of ballot (figure X item 1c—ballot type); and instruction as to what to do with the completed ballot (figure X item 1d—ballot destination instruction).

8.b. voting portion—this portion improves the invention of Kargel by providing vital information to enable the voter to independently make clearly informed decisions regarding the ballot selection options by providing specific information as to the title of political position (figure X item 2A—candidate position description); specific instructions as to how many candidates to select (figure X item 2B—voting instructions); and information as to how to properly select the candidates of choice (figure X item 2C—candidate selection methods); as well as specific descriptions of the candidates to significantly reduce selection errors (FIG. 4 item 2D—candidate names) and an optional description of the candidate political party affiliation (FIG. 4—item 2E). FIG. 4, Item 2F shows two examples of valid selections.

8.c. Ballot ID portion—this portion is unique among registered Patents, and provides a significant improvement in the arts of invention pertinent to this scope of application.

8.c.1. Although this invention was conceived without knowledge of Kargel's invention, there is a common thread whereby each MASTER ballot, and the constituent parts comprising the PRIMARY Ballot, and any number of RECEIPT Ballots, share an identical, identifier. However, Kargel does not specify any characteristics of his identifier, nor its method of assembly, and only a few details of implementation;

8.c.2. This invention improves significantly on Kargel by the use of a Random, Symbolic Identification (FIG. 4 item 3a—Ballot ID in the form of a Random Symbolic Identifier). The Random Symbolic Identifier (RSID) is comprised of a group of randomly selected symbols, which are arranged in a combination that is unique among all RSID's of a Voting Session. Thus each PRIMARY and RECEIPT Ballots that comprise a Master Ballot are uniquely identifiable among all ballots of a Voting Session.

8.c.3.a. This random identifier prevents anyone with any ballot from fabricating a series of ballots, by simply incrementing or decrementing the values used in the reference ballot they possess.

8.c.3.b. This invention shall also include the provision to include a sequential series of symbols, or a repeatable pattern of symbols, should the Officials of the Voting Session desire such a feature. It should be noted that an implementation of either would require corresponding adjustment to this invention, including the understanding that the term RSID would imply either a sequence or pattern for this invention document; It is beyond the scope of this document to speculate at all the possible combinations of symbol sequences or patterns may created for either potential request.

Furthermore, this invention shall also include the methods whereby no group of unique symbols are assigned to uniquely identify any ballot—authentication thereby relies primarily upon the Security Elements of the Ballot. The unique steps of research, computerized data mining of Eligible Voters, mailing ballots and exchanging ballots, and any other applicable parts of this invention would still be included in the no ballot id version of this invention.

This document, however, shall focus on the use of the RSID, with the understanding that other Ballot ID methods may be applied instead.

8.c.4. Another improvement of this invention is to make the RSID to be extremely difficult to guess.

Random Symbolic Identity (RSID)—Mathematics of Binary Encoding

The purposes of the RSID is to enable verification by computer of the ballot identity as an authentication test of validity and to prevent counterfeiting of a multitude of ballots. Using at least one, and possibly two, or more, concatenated symbolic characters as a Random Symbolic ID (RSID) would provide unique identity security of every single ballot (depending on the number of ballots issued) for a single Voting Session.

To understand how this is so, consider that ONE symbolic character can be represented by a unique combination of a sequence of eight (or more.) computer binary digits ranging from 00000000 to 11111111. The sequence of binary digits has a related Base 10 counting system numeric equivalent value.

| ASCII characters | Binary code | Base 10 value |
|---|---|---|
| A | 01000001 | 65 |
| B | 01000010 | 66 |

Concatenating characters increases the number of binary digits that can be interpreted to represent larger binary and numeric (base 10) numbers, as well as for a plurality of counting base methods such as base 8 (octal), base 16 (hexadecimal), etcetera.

| ASCII characters | Binary code | Base 10 value |
|---|---|---|
| BA | 01000010 01000001 | 16961 |
| AB | 01000001 01000010 | 16706 |

Each unique concatenation is a unique combination of symbolic characters. The positional ordering sequence of the concatenated symbolic characters has a unique binary value and a correspondingly unique, equivalent numeric value that can be used to identify a specific sequence of concatenated symbolic characters.

Therefore each and every unique concatenation of symbolic characters also has a unique numeric value associated only with that specific combination of symbolic characters when using a consistent method of assigning each character symbol to only one binary value. (Note: 1×10E3=1,000 1×10E4=10,000 the maximum value of the most significant digit of the binary number is calculated by 2EX where X=number of binary digits.)

| ASCII | Binary | Total | |
|---|---|---|---|
| Characters | Digits | Binary Digits | Maximum Value |
| 8 | ×8 binary | 64 | 1.8 × 10E19 |
| 16 | ×8 binary | 128 | 3 × 10E38 |
| 24 | ×8 binary | 192 | 6 × 10E57 |
| 32 | ×8 binary | 256 | 1 × 10E77 |

To understand how large these numbers are, consider that everything is made of atoms. There are about 3×10E51 atoms on Earth; the entire Universe contains between 10E78 to 10E81 atoms.

Note 1: INTERNET; http://mathforum.org/library/drmath/view/59178.html the mass of the earth is about 6×10E27 grams. pretend the earth is made up entirely of hydrogen atoms (since they are the lightest, so there would be more of those than the actual number of heavier atoms.). One H atom weighs one atomic mass unit, or 1.66×10E-24 grams . . . 6×10E27 g/earth/1.66×10E-24 g/atom=3.6×10E51 atoms on earth.

Note2: INTERNET; http://pages.prodigy.net/jhonig/bignum/qauniver.html estimates for the number of atoms in our galaxy to be in the area of 10E68 . . . there is a wide range of estimates given for the number of galaxies in the universe. Some put the number in the very low 100 billions, others bring it much closer to the one trillion (10E12) mark. The size of other galaxies range from one million to hundreds of billions of stars. The mass of some of the largest galaxies is trillions of times the mass of our sun. Since our galaxy probably has no more than 10E69 atoms, this would mean that at most the universe contains 10E69×10E12 atoms in all. This works out to just under 10E81. If we use lower estimates for the number of atoms in our galaxy and total number of galaxies, then the total number of atoms would be as much as 20 times less, or within the area of 10E79. Hence, atoms in the universe . . . spans from 10E78 to just under 10E81. How effective would a 16 character RSID (3×10E38) relative to the number of voters? What if we divided RSIDs among the entire human population of Earth: 7,000,000,000 3×10E38/7×10E9=4.28×10E28=42,800,000,000,000,000,000,000,000,000 That is how many unique RSID combinations would be available to EACH person on Earth. Guess which ONE they choose!

A supercomputer capable of 4.28×10E12 guesses per second

$$4.28 \times 10 E28 / 4.28 \times 10 E12 = 1 \times 10 E16 / 365 days \times 24 hours \times 3600 seconds = 317 \times 10 E6 = 317 , 000 , 000 YEARS to guess each RSID available to ONE person on Earth ! Good Luck !$$

The actual number of symbols to use for this invention must be calculated, based on the number of voters anticipated, perception of security desired for making the RSID extremely difficult to guess, balanced with the data storage needs, scanning error rate, computer processing error rate and extra communication required for having a large number of symbols comprising each RSID; while also taking into consideration the total number of ballots issued, anticipated number of enquiries, replacements, verifications, authentications, amendments, calculations, publications, etc.

The resulting benefit and application of these mathematical facts and estimates is that any attempts to counterfeit any Ballots are futile, as without a valid RSID, a ballot is rejected by the Voting Session computers. There is no point trying to fake multiple copies of a known PRIMARY Ballot RSID, as only one RSID is considered in the vote records and tallies. When two or more ballots having an identical RSID are detected, the ballots prior and subsequent votes are nullified, then all ballots with the identical RSID are extracted and processed electronically and/or manually to inspect each Ballot composition and Security Elements for Authentication and Validation to certify which ONE ballot to tally for a Vote.

Therefore it is also absolutely vital that valid RSID's created by the Voting Session Officials be kept absolutely secret from all other Voters before and during the voting session. Any public RSID used for trial voting or information purposes should be disallowed in the actual voting records and tallies. To maintain secrecy, before and during the Voting Session, each RSID is known only to the Officials and whomsoever has a PRIMARY or RECEIPT Ballot.

8.c.5. It is also necessary for Officials to organize the RSID;s so as to be rapidly retrieved with a minimum of searching for authentication and validation, which may be accomplished by merging hybridized implementations of n-tree and hashing search methodologies with n-dimensional sparse matrices and any system credit card companies use for validation of credit card numbers.

Constructing an RSID storage system or structure may comprise of the steps: (refer to FIG. 76)

8.c.5.a. for each newly created Random Symbolic Identifier group of symbols:

8.c.5.b. starting at the top level of the computer data structure assigned to contain all RSID;s, whereby the top level comprises of initially of no RSID records whatsoever; set the current record initially to be this top level of records;

8.c.5.c. select the first symbol of the RSID group of symbols using a consistent method (e.g always start at the left) and make that selected symbol the current symbol

8.c.5.d. within the; current record; determine if a record already exists for the current symbol; if a record exists for the current symbol, then assign the; current record; to be the record for the current symbol; then goto step 8.c.5.f.

8.c.5.e. if a record does not exist for the current symbol, create a record for the current symbol; then assign the; current record; to be the newly created record; then goto step 8.c. 5.f;

8.c.5.f. if the current symbol was also the last symbol of the RSID, goto step 8.c.5.g; otherwise, retrieve another symbol of the RSID (using a consistent method for all RSIDs), then set the newly retrieved symbol to be the current symbol; then go back to 8.c.5.d;

8.c.5.g. if this is the last symbol of the RSID, place at least one copy of the RSID inside the record for the last symbol, for use as confirmation, along with any other information deemed necessary to the Voting Session.

8.c.5.h. terminate assembly of data storage for RSID; log RSID creation, also noting date and time, and any internal sequence number used to store the RSID in any computer database;

8.c.5.i. repeat steps 8.c.5.a. to 8.c.5.h. until the required number of RSIDs are generated to make the required number of Master Ballots and any extra ballots;

8.c.6. For this invention, the steps of verifying an RSID may comprise the steps of: (refer to

8.c.6.a. starting at the top level of the computer data structure assigned to contain all RSIDs, whereby the top level comprises at least of one record for each symbol that was used to create the first symbol every RSID generated for the Voting Session; set the current record initially to be this top level of records;

8.c.6.b. scanning each symbol of the RSID, in a consistent method, identical to that which was used to construct the RSID storage records, (for example: always leftmost to rightmost), or by deriving the RSID from the barcode correlated to the RSID, so as to acquire the entire sequence of symbols, in the exact same order as the RSID of the Ballot.

8.c.6.c. select the first symbol of the RSID group of symbols using a consistent method identical to that which was used to construct the RSID storage records, (e.g. always start leftmost to rightmost), and make that selected symbol the current symbol;

8.c.6.d. determine if a computer record exists for the current symbol, within the current record;

8.c.6.e. if a record exists for the current symbol, make the current record to be that record for the current symbol, then proceed to step 8.c.6.g.

8.c.6.f. if a record does not exist for the current symbol, within the current record, terminate the search as the current symbol is not found, therefore the RSID was never assigned to any authentic MASTER Ballot; goto step 8.c.6.h.;

8.c.6.g. if that was that the last symbol of the RSID, goto step 8.c.6.h.; otherwise make the next selected symbol of the RSID (using the identical selection method as used to construct all RSIDs) to be the current symbol; then go back to step 8.c.6.d.;

8.c.6.h. search inside the last current record assigned for the last symbol of the RSID, this record should contains a matching RSID for confirmation, and any other information deemed necessary to the Voting Session.

8.c.6.i. terminate RSID search operation

8.c.6.j. transmit search results with a message to accept or reject the RSID authenticity; —OR—

8.c.7.a. create search subsets by presorting RSIDs into groups with common prefixes, or, sorting by values from computer hashing function algorithms or an search structures such as array of n-tree linked lists;

8.c.7.b. search all the subsets of RSID records of step 8.c.7.a. using appropriate methods;

8.c.7.c. terminate RSID search operation;

8.c.7.d. transmit search results with a message to accept or reject the RSID authenticity;

8.c.8. Furthermore, it is also necessary to ensure there is a large set of unique symbolic characters to choose from when randomly selecting and constructing the RSID. This can be accomplished by the methods and steps whereby computers run software employing rigorous mathematical concepts to first create large and varied sets of unique symbols, then assigning a unique binary value to each symbol of the set; followed by randomly selecting from the set of unique symbols for the purpose of assembling a unique group of symbols to comprise each RSID;

The steps whereby a set of unique symbols is constructed is comprised of at least the steps of:

8.c.8.a. defining the maximum number of Random Symbolic Identifiers needed to ensure that any one RSID is unique and extremely difficult to guess. (e.g. 1 million)

8.c.8.b. calculating the minimum number of binary digits needed describe the maximum number of Random Symbolic Identifiers of step 8.c.8.a. (e.g. 20 binary digits is just over 1 million, 21 binary digits is 2 million=too much)

8.c.8.c. calculating the number of unique RSID symbols needed to enable generating a sufficient number of unique permutations of symbols to be assigned to each Ballot of the Voting Session; (e.g. 2 letters A,B yields 4 unique permutations AA, AB, BA, BB that can be assigned to a maximum of 4 ballots)

8.c.8.d. creating a mathematically null, empty set of symbols;

8.c.8.e. constraining the set of claim 8.c.8.d. so that it will accept, contain, and emit only symbols capable of representation in two dimensions;

8.c.8.f. adding any number of symbols used in any written human language to the set of step 8.c.8.e.

8.c.8.g. adding any number of numeric symbols to the set of 8.c.8.f.

8.c.8.h. creating a unique symbol comprising any combination of at least one shape; line, curve, arc or dots that can be expressed in two dimensional form;

8.c.8.i. adding any number of created symbols of step 8.c.8.h. to the set of step 8.c.8.g

8.c.8.j. sorting, organizing, ordering and enumerating the symbols in the set of 8.c.8.i.

8.c.8.k. removing all identical symbols from the set of step 8.c.8.j.;

8.c.8.l. removing all similar symbols except for one from the set of step 8.c.8.k.; (e.g. letter O and number 0 can be easily confused so use just one)

8.c.8.m. further reducing or adding symbols as described previously to the set of step 8.c.8.l. so as to achieve the desired number of symbols of step 8.c.8.c. (to achieve the necessary diversity of symbols used to generate the required range of values to create unique, extremely difficult to guess, random symbolic identifiers);

8.c.8.n. assigning a unique binary value to each unique symbol in the set of step 8.c.8.m.

8.c.8.o. assigning a unique base ten number to each unique binary value of step 8.c.8.n;

8.c.8.p. assigning to this step, a unique set comprising of the set of 8.c.8.m. and the steps of; 8.c.8.n. and 8.c.8.o.

8.c.9. The steps of assembling an RSID using a set of unique symbols obtained from step; 8.c.8.p. for the purpose of making any MASTER Ballot or any of its parts, uniquely identifiable among ballots within a Voting Session, comprising of at least the steps of:

8.c.9.a. creating a zero dimensional, mathematical series of symbols;

8.c.9.b. executing or running at least one computer program to perform a mathematically random selection of at least one symbol from the set of symbols of step 8.c.8.p.;

8.c.9.c. concatenating or inserting the symbol or group of symbols of step 8.c.9.b. into the series of step 8.c.9.a.;

8.c.9.d. enumerating or counting the number of symbols in the series of step 8.c.9.c.

8.c.9.e. repeating steps 8.c.9.c. followed by step 8.c.9.d. until the count of symbols equals the number of RSID symbols specified in step 8.c.9.c.

8.c.9.f. of making the Random Symbolic Identifier (RSID) identical and equal to the series of symbols generated according to steps 8.c.9.a. to 8.c.9.e.

8.c.9.g. concatenating each binary value in sequence for each RSID symbol of 8.c.9.f. to create a unique binary number;

8.c.9.h. assigning a unique base 10 number to each unique binary number of step 8.c.9.g.

8.c.9.i. assigning a unique barcode symbol to each unique RSID of 8.c.9.f. or 8.c.9.h.;

8.d. To facilitate computer processing of ballots, a unique barcode is generated for each unique RSID (figure X item 3b—Barcode representation of the RSID) and correlated to the same MASTER Ballot and constituent Ballot parts that share the correlated RSID;

8.e. To further reduce errors in computer ballot processing a warning is included (figure X item 3c—ballot processing warning), to reduce the amount of manual processing required.

8.f. To further reduce and detect errors, the RSID symbols are also scanned and compared to the RSID derived from the scanned barcode of 8.d. for corroboration of the RSID.

8.g. Security Elements portion—This is another unique feature of this invention with respect to other inventions of the scope of this art. This feature is a vital feature to ensure the integrity of the ballot, in order to guarantee the final vote tallies are not unfairly influenced by the creation of fictitious voters. The Random Symbolic Identifier, can also be considered as another form of a Security Element; however, the ballots of this invention may not be limited only to a RSID.

Security Elements (figure X item 4a—Security Elements) are designed to assist with authentication of any Ballot, whereby the Security Elements are comprised of any number of: Random Symbolic Identifier codes of 8.c., physical characteristics or devices, optical structures or devices, electronic devices or structures, magnetic fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, impressions, watermarks, seals of authenticity affixed or associated, and any other physical structures, or any other properties associated with any ballot;

8.h. Limits of Use Portion

The variety of Voting Sessions possible requires that this section of the Ballot be considered as a variable data area. The Limits of Use area of the Ballot contains several data fields, which can be considered to be “data containers”, whereby any single “data container” may be displaying a combination of several distinct items of related information derived from various sources of information (e.g. using several related data fields of a database—FIGS. 53 and 54).

Voting Region is used to describe the Scope of a Voting Session—refer to Entity-Relation Diagrams of FIGS. 54 to 60, and FIGS. 69 to 72.

Voting Region is also used to refer to a variable group of attributes—Province or State, Municipality, Zone, Poll Station, Postal or Zip Code.

The attributes are used for data storage, and may also be components of the Voting Region, depending on the Scope of the Voting Session.

Any number of Voting Region attributes may be visible on Ballots, Reports, Calculations, Tallies, Summaries, etcetera as determined by Officials to meet the needs of a particular Voting Session.

(Refer to FIGS. 61,73, 74, 75)

8.h.1.a. the Voting Region identifier (figure X item 5a—RegionID) is a unique identifier that is used to further define the scope of application of the ballot; such that it is correlated to a geographic area; or a subset of a group of people or legally recognized entities; or a membership to a group or subset of a group of people or legally recognized entities; Item 5b of figure X is a barcode correlated to the value of item 5a of figure X.

8.h.1.b. Referring to FIGS. 45 and 51—item 5c is a Voting Region Name Description for ease of human interpretation to facilitate ballot exchanges and other human processing of ballots.

8.h.1.c. Referring to FIG. 45—item 5a is the Zone Identifier; item 5c is a Zone Name Description for item 5a; item 5b is a barcode for items 5a and/or 5c; Item 8a is a Polling Station identifier which is an attribute (or component) of the Voting Region; to facilitate more detailed analysis of voter responses. Item 8b is a barcode correlated to the value of item 8a.

8.h.1.d. Referring to FIGS. 51 and 66—Item 5a is the ZONE Identifier; Item 5D is a Polling Station identifier attribute of the Voting Region (and Zone) for ease of human interpretation to facilitate ballot exchanges and other human processing of ballots. Item 5b is a barcode correlated to the value of items 5a and 5D.

Referring to FIG. 51—items 5E and 8a are a combination of the Province attribute (item 5E) of the Voting Region and the Host Identifier (item 8a) placed side by side for ease of human interpretation to facilitate ballot exchanges and other human processing of ballots.

8.h.1.e. Referring to FIG. 62—item 5E is a Postal Code identifier which is an attribute (or component) of the Voting Region and of the ZONE ID to facilitate more detailed analysis of voter responses. Item 5F is a barcode correlated to the value of item 5E.

8.h.1.f. Referring to FIGS. 63, 67 and 68—item 5a is a general Voter Region Name Description; item 5b is a detailed description of the Voter Region displaying all of the component attributes (Zone ID, Poll Station ID, Post Code) for ease of human interpretation to facilitate ballot exchanges and other human processing of ballots. Item 5c is a barcode for all of the Voter Region attributes correlated to the value of items 5a and/or 5b.

8.h.1.g. Referring to FIG. 63, item 7a displays an abbreviation of the Title of the Political Duty regarding the purpose of the ballot being a Candidate Election to a Political Duty. Item 7b is the human readable symbols for the UNIQUE code associated to the Political Duty, which may be used for election accounting of ballots, or verification for ballot exchange or other ballot processing as well as ballot cost accounting.

Item 7b may include any number of human readable symbols to designate this a Candidate ballot (item 7a).

Item 7c is barcode correlated to the value of item 7b.

8.h.1.h. Referring to FIGS. 67 and 68—item 7a displays the ballot purpose “PROPOSALS” as well as the associated code symbols (item 7b) assigned to the group of Proposals on the Ballot (e.g. one new, UNIQUE code for several proposals); or the codes symbols used by any number of the proposals specified on the Ballot (e.g. a proposal code is used).

The associated code symbols (item 7b) may be used for election accounting of ballots, verification for ballot exchange or other ballot processing such as cost accounting. Item 7b may include any number of human readable symbols to designate this as a Proposal Ballot (item 7a).

Item 7c is barcode correlated to the value of item 7b.

8.h.2. ballot delivery due time and date identifiers

8.h.3.a. the delivery due date (figure X item 6a—duedate) describes the latest date the ballot is required to be delivered to the designated receiver(s) for the Voting Session.

8.h.3.b. the delivery due time (figure X item 6b—duetime) describes the latest time the ballot is required to be delivered to the designated receiver(s) for the Voting Session.

8.h.3.c. Item 6c is a combined barcode for both the due date and due time or separate distinct barcodes for zero or more expressions of the due date or due time.

8.h.4. political duty identifier or, proposal ballot identifier; or a hybrid of both candidates and proposals identifiers (candi-props);

8.h.4.a. in the case of an election candidate, this identifier (figure X item 7a—dutyID), is used to encode the description of the political position the candidate seeks election to fulfill the duties of; Item 7b is a barcode correlated to the value of item 7a.

8.h.4.b. in the case of a proposal ballot identifier, the identifier is used to encode the description of at least one proposal being voted to accept or reject.

8.h.5.a. the voting session official host identifier (figure X item 8a—HostID) is a unique identifier used to initially determine the scope whereby ballot is to be applied for use; and is assigned to any group, or organization or business comprising of at least one person or other legal entities; Item 8b is a barcode correlated to the value of item 8a.

8.h.5.b. an alternative to 8.h.5.a. is the use of a Polling Station Identifier (FIG. 45—item 8a) which identifies at least one sub-region within a Zone or Region ID described in 8.h.1.a. useful to assist interpreting voter responses within a Zone or Region ID. Item 8b is a barcode correlated to the value of item 8a.

8.h.5.c. Referring to FIG. 51 to reduce human error when exchanging or processing ballots, an alternative to 8.h.5.b. is the use of an integral Polling Station Identifier (item 5D) that identifies any number of sub-regions within a Zone or Region ID (item 5a). Item 5c remains the Region Name description to ease human interpretation; whereas item 5b is a single barcode or group of adjacent barcodes, correlated to the values of items 5a and 5D. Item 5E is a continuation of the Name description (item 5c), adjacent to the name of the Voting Session Host (item 8a). Item 8b is a single barcode or group of adjacent barcodes, correlated to the values of items 5E and 8a.

8.h.6. To further reduce and detect errors, the identifier symbols of 8.h.1. to 8.h.5. are also scanned and compared to their respective scanned barcode(s) for corroboration of data.

9. each Voter chooses their Candidate or Proposal selections on the MASTER ballot; whereby the mark may be a circle, X, filled in circle, or whatever other mark, in whatever form (e.g electronic mark) is deemed acceptable to Officials or the Rules of the Voting Session;

10. each Voter keeps the RECEIPT Ballot parts of the MASTER ballot;

11. each Voter delivers, or arranges for the delivery of, the PRIMARY Ballot part of the MASTER Ballot, to the Voting Session Officials, before the due date and time;

12. to record their vote selections, each Voter delivers or arranges the physical delivery of the printed Primary Ballots they possess to Officials;

In order to facilitate on time delivery of Ballots to meet criteria for due dates and due time, a variety of additional methods to cast ballots are provided to voters—PHONE Ballots, INTERNET Ballots, FAX Ballots; all intended to supplement, but not replace, the physical delivery of the printed Ballots, unless any of PHONE, INTERNET or FAX Ballots are designated acceptable to replace a printed Primary Ballot according to Voting Session Rules.

Thus, delivery of printed Primary Ballots can be made by the voter, a trusted third party, a post office, a delivery service, courier service, facsimile machine, computerized facsimile service, telephone or via at least one computer and communications network connected to the Internet. In a typical Voting Session, the delivery of the printed Primary Ballot may be required to enable authentication of selections on the Ballot.

12.a. TELEPHONE BALLOTS—the methods to submit via telephone, any number of PHONE Ballots to vote, report errors in, or, request investigation of, Official records, tallies, calculations, summaries or publications, whereby:

12.a.1. Audio recording equipment is used by Officials to make at least one audio record of the telephonic contact, which is retained as a record for every PRIMARY Ballot or RECEIPT Ballot the Voter alleges to possess;

12.a.2. the steps of receiving, detecting, reporting and correcting any significant compromises in every PHONE recording of 12.a.1.;

12.a.3. the step of referring to the PHONE record of step 12.a.1. as an PHONE Ballot;

12.a.4. the step of retaining every PHONE Ballot until such time any number of PRIMARY Ballot or RECEIPT Ballots are received for authentication and validation by any number of Officials in accordance with the rules of the Voting Session;

12.a.5. the further step of claim 12.a.1. whereby PRIMARY Ballots or RECEIPT Ballots must be submitted within the time and date guidelines for the Voting Session;

12.a.6. the further step of Officials or Official computers actively working to determine whether each of the PRIMARY Ballot or RECEIPT Ballot identifications provided in each PHONE Ballot is AUTHENTIC and VALID;

12.a.7. The step according of receiving any number of PRIMARY Ballots or RECEIPT Ballots delivered to the Officials of the Voting Session;

12.a.8. For every PHONE Ballot, the steps of detecting and reporting failures of delivery of a PRIMARY Ballot or RECEIPT Ballot that was to be correlated to a PHONE Ballot;

12.a.9. disregarding the PHONE Ballot should a PRIMARY Ballot or RECEIPT Ballot fails to be delivered, according to step 12.a.8., within the Rules of the Voting Session;

12.a.10. each PHONE Ballot has at least one status attribute with a variable value that is defined by Officials;

12.a.11. receiving any number of PHONE, MASTER, PRIMARY, or, RECEIPT Ballots;

12.a.12. authenticating, validating or certifying any number of qualifying PHONE, MASTER, PRIMARY, or, RECEIPT Ballots;

12.a.13. correlating each PHONE Ballot to a MASTER, PRIMARY or RECEIPT Ballot;

12.a.14. changing at least one status attribute of the PHONE Ballot based on the results of attempting correlation of step 12.a.13

12.a.15. Accepting the PRIMARY or RECEIPT Ballots as being filed in a timely manner; and submitting the ballots to further processing for recording and tallying;

12.a.16. Rejecting any number of PHONE, PRIMARY, or, RECEIPT Ballots as not being filed in time;

12.a.17. disregarding any number of Voting Portions of the PHONE Ballot that disagree with Voting Portions of the correlated PRIMARY or RECEIPT Ballots;

12.a.18. receiving, detecting, reporting and correcting any compromises or errors;

12.b. Internet Ballots

12.b. methods to submit via the INTERNET, any number of INTERNET Ballots to vote, report errors in, or, request investigation of, Official records, tallies, calculations, summaries or publications, whereby:

12.b.1. Recording equipment is used to make at least one record of the INTERNET contact, which is retained as a record for every PRIMARY Ballot or RECEIPT Ballot the Voter alleges to possess;

12.b.2. the steps of receiving, detecting, reporting and correcting any significant compromises in every INTERNET recording of step 12.b.1.;

12.b.3. referring to the INTERNET record of claim 12.b.1. as an INTERNET Ballot;

12.b.4. retaining every INTERNET Ballot until such time any number of PRIMARY or RECEIPT Ballots are received for authentication and validation by Officials;

12.b.5. INTERNET Ballots must be submitted within the time and date guidelines for the Voting Session;

12.b.6. Officials receive any number of INTERNET Ballots, PRIMARY Ballots, or RECEIPT Ballots that are delivered to the Officials of the Voting Session;

12.b.7. For every INTERNET Ballot, the steps of detecting and reporting failures of delivery of a PRIMARY or RECEIPT Ballot that was to be correlated to an INTERNET Ballot;

12.b.8. disregarding the INTERNET Ballot should a PRIMARY Ballot or RECEIPT Ballot used for verification of the INTERNET ballot fail to be delivered according to the Rules of the Voting Session;

12.b.9. each PHONE Ballot has at least one status attribute with a variable value that is defined by Officials;

12.b.10. each INTERNET Ballot has at least one status attribute with a variable value that is defined by Officials;

12.b.11. receiving any number of INTERNET, MASTER, PRIMARY, or, RECEIPT Ballots;

12.b.12. authenticating, validating or certifying any number of INTERNET, MASTER, PRIMARY or RECEIPT Ballots;

12.b.13. correlating each INTERNET Ballot to a MASTER, PRIMARY or RECEIPT Ballot;

12.b.14. changing at least one status attribute of the INTERNET Ballot based on the results of attempting correlation of step 12.b.13.

12.b.15. Accepting the PRIMARY or RECEIPT Ballots as being filed in a timely manner; and submitting the ballots to further processing for recording and tallying;

12.b.16. Rejecting any number of INTERNET, PRIMARY, or, RECEIPT Ballots as not being filed in a timely manner;

12.b.17. disregarding any number of Voting Portions of the INTERNET Ballot that disagree with Voting Portions of the correlated PRIMARY or RECEIPT Ballots;

12.b.18. receiving, detecting, reporting and correcting any compromises or errors;

12.c. FAX Ballots—this unique method of this invention, extending all registered patents, provides the methods to submit a copy of the PRIMARY Ballot or RECEIPT Ballot via a facsimile machine to Officials; to cast ballots to vote, report errors in, or, request investigation of, Official records, tallies, calculations, summaries or publications, whereby:

12.c.1. Facsimile equipment or computerized facsimile services are used by Officials to make at least one electronic or one paper record of the facsimile contact, that are retained as a record for every PRIMARY Ballot or RECEIPT Ballot the Voter alleges to possess;

12.c.2. the steps of receiving, detecting, reporting and correcting any significant compromises in every FAX recording of step 12.c.1.;

12.c.3. the step of referring to the FAX record of step 12.c.1. as a FAX Ballot;

12.c.4. the step of retaining every FAX Ballot until such time any number of PRIMARY Ballot or RECEIPT Ballots are received for authentication and validation by any number of Officials in accordance with the rules of the Voting Session;

12.c.5. the further step of 12.c.1. whereby FAX Ballots must be submitted within the time and date guidelines for the Voting Session;

12.c.6. the further step of Officials actively work to determine whether each of the PRIMARY Ballot or RECEIPT Ballot identifications provided in each FAX Ballot is AUTHENTIC and VALID;

12.c.7. The step according of receiving any number of PRIMARY Ballots or RECEIPT Ballots delivered to the Officials of the Voting Session;

12.c.8. For every FAX Ballot, the steps of detecting and reporting failures of delivery of a PRIMARY Ballot or RECEIPT Ballot that was to be correlated to a FAX Ballot;

12.c.9. disregarding the FAX Ballot should a PRIMARY Ballot or RECEIPT Ballot fail to be delivered, according to 12.c.8. within the Rules of the Voting Session;

12.c.10. each INTERNET Ballot has at least one status attribute with a variable value that is defined by Officials;

12.c.11. receiving any number of FAX, MASTER, PRIMARY, or, RECEIPT Ballots;

12.c.12. authenticating, validating or certifying any number of FAX, MASTER, PRIMARY or RECEIPT Ballots;

12.c.13. correlating each FAX Ballot to a MASTER, PRIMARY or RECEIPT Ballot;

12.c.14. changing at least one status attribute of the FAX Ballot based on the results of attempting correlation of step 12.c.13.

12.c.15. Accepting the PRIMARY or RECEIPT Ballots as being filed in a timely manner; and submitting the ballots to further processing for recording, tallying, calculations, and publication;

12.c.16. Rejecting any number of FAX, PRIMARY, or, RECEIPT Ballots as not being filed in a timely manner;

12.c.17. disregarding any number of Voting Portions of the FAX Ballot that disagree with Voting Portions of the correlated PRIMARY or RECEIPT Ballots;

12.c.18. receiving, detecting, reporting and correcting any compromises or errors;

14. Officials receiving any number of PRIMARY Ballots, or, any number of RECEIPT Ballots, or, any number of both PRIMARY Ballots and RECEIPT Ballots, or any number of AUDIO Ballots, or any number of INTERNET Ballots.

15. Officials accept or reject the validity of each ballot of 14. for the specified Voting Session; and the further step of accepting only verified, VALIDATED ballots for recording and tallying;

16. Officials accept or reject the authenticity of each ballot of 15.

17. Officials designate verified, authenticated ballots as certified ballots;

18. Officials accept only certified ballots for recording, tallying, calculating, summarizing publishing and certifying of results;

19. Officials determine whether the ballots of step 18. were processed or recorded previously;

20. Officials accept or reject the ballots of 19 based on the determination findings;

21. Officials record, tally, summarize, calculate and publish all of the voter selections only for certified ballots that were cast by voters and received by Officials; and the further step of organizing received Ballots so as to be easier to locate and retrieve for verification;

22. Officials provide each Voter with at least one method, and at least one opportunity, to verify or correct the accuracy of the Official Record of any record, tally, calculation, summary, or publication pertaining to any certified ballots or certified ballot vote selections.

23. Using their RECEIPT Ballot and a telephone, or, a computer connected to the Internet, any number of Voters verify or reject any Official record, tally, calculation, summary, or publication pertaining to their PRIMARY Ballot or voting selections made on their PRIMARY Ballot.

24. Voters notify Officials to investigate and correct any errors discovered in step 23.

25. Officials record the Voter request to investigate, along with all relevant details;

26. Officials proceed to investigate whether to accept or reject each Voter request to amend any errors;

27. Officials report to Voters, and record in the Official records, as to whether an amendment is required as requested, along with the Official findings of the investigation;

28. If required, Officials then amend the records, tallies, summaries, calculations, and publications to correct the records and tallies of any number of PRIMARY Ballots, or voter selections made on the PRIMARY Ballots, in accordance with the findings of 27 and the Rules of the Voting Session.

29. Officials verify any amendments were completed accurately;

30. Officials report to Voters, and record in the Official records, when the amendments are completed, and the results of the Official verification of the amendments;

31. Officials provide each Voter with at least one method, and at least one opportunity, to accept or reject the accuracy of any amended records, tallies, summaries, calculations, or publications.

32. Voters verify correctness or report errors in the amendment to Officials,

33. Officials and Voters repeat steps 26 to 30 according to the rules of the Voting Session.

34. Officials verify, validate, then publishing the final amended records, tallies, calculations, summaries in accordance with the Rules of the Voting Session.

35. Officials certify the final results of the Voting Session;

36. Officials declare the Voting Session complete and the Voting Session is closed. - - - end of general declaration section - - -

1. The steps and methods of Officials conducting a Voting Session whereby any number of Officials use the steps and methods of claim 10 to identify, research and assign any number of people or other legal entities to, at most, one type of Voters List (such as, but not limited to—Eligible Voters List, Proxy Voters List, Potential Voters List, or Ineligible Voters List); and the further step whereby each Eligible Voter, Proxy Voter, Potential Voter, or, Ineligible Voter is assigned one unique identification symbol or groups of symbols known as a Master Voter ID (MVID) to distinguish each person or legal entity from other voters or legal entities on the same Voters List or any other Voters List of this invention; and the further step whereby each type of Voters List is assigned a unique symbol or group of symbols to distinguish it from other types of Voter Lists; and the further steps and methods of any number of Officials creating any number of duplicate copies of any number of each type of Voters Lists, and the further steps and methods of Officials processing any number of Voters Lists using the steps and methods of claim 10; and the further steps and methods whereby each Voter is assigned a Master Voter Identifier (MVID) that is unique among all Voters, and therefore unique among all Voter Lists of this invention.

2. The steps and methods of Officials conducting a Voting Session according to claim 1, whereby any number of Officials correlate any number of unique Master Voter Identifiers (MVID's) and any number of Voters Lists of claim 1 to any number of Master Voter Registration forms of this claim, whereby each Master Voter Registration form is comprised of two parts, whereby one part is a Primary Voter Registration form (FIG. 1) and the second part is comprised of any number of Receipt Voter Registration forms (FIG. 2), such that each Primary and Receipt parts of each Master Voter Registration is assigned at least one unique identifier known as a Voter Registration ID (VRID) to distinguish each Master Voter Registration form (and its constituent parts) from all other Master Voter Registrations forms (and their constituent parts), and furthermore that for each Master Voter Registration form, the component Primary Voter Registration form and all Receipt Voter Registration forms (for the same Master Voter Registration form), contain identical Voter Registration information and are correlated to each other by sharing the same unique VRID identifier that is printed, embedded or linked to each part of the Master Voter Registration form; and the further steps and methods whereby each Master Voter Registration form (and each Primary and Receipt part) is comprised of (but not limited to)—at least one portion containing elements of voting information (such as, but not limited to—voting session name, voting session type, Voter Registration ID (VRID), assigned Voter Address identifier (VAID)) whereby each element of voting information is correlated to any number of scanning codes (such as but not limited to barcodes), and the further steps of assigning at least one portion for recording voter identification, at least one portion for recording the voters legal name, any number of portions for recording the voters signature, at least one portion for recording the date of Registration form completion; and the further steps and methods whereby each Receipt Registration form is manufactured so as to be easily distinguishable from the Primary Registration form using any combination of—additional word markings such as but not limited to the word RECEIPT, raised symbols (such as, but not limited to Braille codes), any number of different colors, different texture, or different materials, different physical, electronic, electromagnetic, or optical representation, or any other form of representation that differs from that which is used to manufacture the PRIMARY Registration form, which may include linking, attaching or embedding any number and combination of (but limited to)—printed symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing, embossing or any other physical structures associated uniquely and directly with the RECEIPT Registration form so as to distinguish each RECEIPT Registration form from every PRIMARY Registration forms; and the steps and methods of printing, assigning, linking, correlating or embedding any number of Security Elements of claim 7 (such as, but not limited to RSID, holograms) for each Registration form (Master, Primary, or Receipt); and the further steps and methods for each Registration form of allocating identical portions for Voters or Officials to mark and record information comprising of, but not limited to—any number of personal identifiers, any number of printed names, any number of signatures, any number of date information, any number of location information; and the further steps and methods for each printed Master Voter Registration forms of printing, attaching or embedding, any number of optical scanning markings, alignment markings or skew markings to ensure proper optical scanning, and the further steps and methods of consistently shaping, or cutting away, or marking at least one corner of each Master Voter Registration form (and each Primary Voter Registration forms and each Receipt Voter Registration forms) so as to identify a consistent orientation (such as, but not limited to: front face in view and top edge uppermost) to assist in sorting, organizing, scanning, counting and any other human, mechanical, optical, electronic or hybrid processing or other processing according to claim 10 of any number of Voter Registration forms (Master, Primary or Receipt); and the further steps and methods for each electronic Voter Registration forms (Master, Primary and Receipt) of processing according to, but not limited by, claim 10 to ensure data accuracy, integrity, and longevity.

3. The steps and methods of conducting a Voting Session whereby any number of Officials correlate any number of unique Master Voter Identifiers (MVID's) and any number of Voters Lists of claim 1 to any number of Master Voter Language forms of this claim, or, any number of Master Voter Registrations of claim 2 to any number of Master Voter Language forms of this claim; and the further steps and methods of processing according to claim 10, any number of Master Voter Language forms, any number of Primary Voter Language forms, any number of Receipt Voter Language forms, whereby each Master Voter Language form is comprised of two parts, whereby one part is a Primary Voter Language form (FIG. 3) and the second part is comprised of any number of Receipt Voter Language forms (FIG. 4), such that each Primary and Receipt parts of each Master Voter Language form is assigned at least one unique identifier known as the Voter Language ID (VLID) to distinguish the Master Voter Language forms (and its constituent parts) from all other Master Voter Language forms (and their constituent parts), and furthermore that for each Master Voter Language form, the component Primary Voter Language form and all Receipt Voter Language forms (for the same Master Voter Language form), are nearly identical and are correlated to each other by sharing the same unique MLID identifier that is printed, embedded or linked to each part of the Master Voter Language form; the steps and methods of printing, assigning, linking, correlating or embedding any number of Security Elements of claim 7 (such as, but not limited to RSID, holograms) for each Language form Master, Primary, or Receipt); and the further steps whereby at least one portion containing elements of voting information, correlated to any number of barcodes or other optical scanning markings, at least one portion containing additional information, and the further steps and methods whereby each Receipt Language form is manufactured so as to be easily distinguishable from the Primary Language form using any combination of—additional word markings such as but not limited to the word RECEIPT, raised symbols (such as, but not limited to Braille codes), any number of different colors, different texture, or different materials, different physical, electronic, electromagnetic, or optical representation, or any other form of representation that differs from that which is used to manufacture the PRIMARY Language form, which may include linking, attaching or embedding any number and combination of (but limited to)—printed symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing, embossing or any other physical structures associated uniquely and directly with the RECEIPT Language form so as to distinguish each RECEIPT Language form from every PRIMARY Language forms; and the further steps and methods for each Language form of allocating identical portions for Voters to mark and record information comprising of, but not limited to—any number of personal identifiers, any number of Voter Language Selections information, any number of date information, any number of location information; any other Language or Voter information; and the further steps and methods for each printed Master Voter Language forms of printing, attaching or embedding, any number of optical scanning markings, alignment markings or skew markings to ensure proper optical scanning, and the further steps and methods of consistently shaping, or cutting away, or marking at least one corner of each Master Voter Language form (and each Primary Voter Language forms and each Receipt Voter Language form) so as to identify a consistent orientation (such as, but not limited to: front face in view and top edge uppermost) to assist in sorting, organizing, scanning, counting and any other human, mechanical, optical, electronic or hybrid processing or other processing according to claim 10 of any number of Voter Language forms (Master, Primary or Receipt); and the further steps and methods for each electronic Voter Language forms (Master, Primary and Receipt) of processing according to claim 10 to ensure data accuracy, integrity, and longevity.

4. The steps and methods of conducting a Voting Session according to claims 1,2,3 whereby any number of Officials correlate any number of unique Master Voter Identifiers (MVID's) and any number of Voters Lists of claim 1 to any number of Master Voter Ballots of this claim, or, any number of Master Voter Registrations of claim 2 to any number of Master Voter Ballots of this claim; and the further steps and methods of defining, designing, verifying, correlating, amending, certifying, preparing, organizing, sorting, assembling, recording, storing, printing, publishing, distributing, receiving, validating, authenticating, and processing any number of Master Ballots, any number of Primary Ballots, any number of Receipt Ballots, whereby each Master Ballot is comprised of parts, whereby one part is the Primary Ballot (FIG. 5,7,9, etc.) and any other parts are comprised of at least one Receipt Ballot (FIG. 6,8,10), such that each Primary and Receipt parts of each Master Ballot are assigned at least one unique Ballot Random Symbolic Identifier (Ballot RSID), which is prominently visible on the Master Ballot (and component Primary and Receipt parts) so as to distinguish that Master Ballot (and all of its component parts) from all other Master Ballots (and their component parts) and furthermore that for each Master Ballot component Primary Ballot and all of the Receipt Ballots of the same Master Ballot are correlated to each other by sharing the same unique Ballot RSID identifier that is printed, embedded or linked or otherwise displayed prominently on each Primary Ballot and Receipt Ballot part of the Master Ballot such that each Receipt Ballot is manufactured so as to be easily distinguishable from the Primary Ballot to the using any combination of—additional word markings (such as but not limited to the word RECEIPT), raised symbols (such as, but not limited to Braille codes), any number of different colors, different texture, or different materials, different physical, electronic, electromagnetic, or optical representation, or any other form of representation that differs from that which is used to manufacture the PRIMARY Ballot, which may include any combination of (but limited to)—printed symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing, embossing or any other physical structures associated uniquely and directly with the RECEIPT Ballot so as to distinguish each RECEIPT Ballot from every correlated or non-correlated PRIMARY Ballot; and the further step whereby at least one Ballot RSID is comprised of numbers, symbols or a group of numbers and symbols, randomly generated to be of a length, content, and construction as to be extremely difficult to guess by chance or to determine (even when assisted by at least one computer running software programs for such purpose), and the further steps and methods whereby any number of unique codes (such as, but not limited to—a binary digital numeric code, a binary digital ASCII code) are consistently created, assigned, associated, stored, retrieved, communicated and processed according to claim 10 for each unique group combination of Ballot RSID numbers, Ballot RSID symbols or Ballot RSID groups of numbers and symbols; and the further steps and methods whereby at most one currently valid PassCode RSID is correlated to each Ballot RSID, and whereby at most one currently valid PassCode RSID is immutably recorded and stored with the associated Ballot RSID; and whereby the PassCode RSID is comprised of numbers, symbols or a group of numbers and symbols, is randomly generated to be of a length, content, and construction as to be difficult to guess or determine, and the further steps and methods whereby any number of unique codes (such as, but not limited to—a binary digital numeric code, a binary digital ASCII code) are consistently created, assigned, associated, stored, retrieved, communicated and processed according to claim 10 for each unique group combination of PassCode RSID numbers, PassCode RSID symbols or PassCode RSID groups of numbers and symbols, and furthermore that each PassCode RSID is printed, associated or linked with at most, one Primary Ballots, at most each Receipt Ballot or at most one Master Ballot container; and the further steps and methods whereby the PassCode RSID is hidden from viewing by a removable covering or openable container such that the only way for the PassCode RSID to be viewable will automatically create evidence of having been revealed; and for each Primary Ballot, each Receipt Ballot and each PassCode RSID of each Master Ballot; the steps and methods of printing, assigning, linking, correlating or embedding any number of Security Elements of claim 7 (such as, but not limited to Ballot RSID, holograms) for each Ballot (Master, Primary, or Receipt),and the further steps and methods for each Ballot of allocating identical portions for Voters to mark and record information comprising of, but not limited to—having at least one portion for selecting at least one candidate, at least one proposal, or both of at least one candidate and at least one proposal, at least one portion containing elements of voting information, correlated to any number of barcodes or other optical scanning markings, at least one portion containing additional information; and the further steps and methods for each printed Master Ballot of printing, attaching or embedding, any number of optical scanning markings, alignment markings or skew markings to ensure proper optical scanning, and the further steps and methods of consistently shaping, or cutting away, or marking at least one corner of each Master Ballot (and each Primary Ballot and each Receipt Ballot) so as to identify a consistent orientation (such as, but not limited to: front face in view and top edge uppermost) to assist in sorting, organizing, scanning, counting and any other human, mechanical, optical, electronic, or hybrid processing or other processing according to claim 10 of any number of Ballots (Master, Primary and Receipt); and the further steps and methods for each electronic Ballot (Master, Primary and Receipt) of processing according to claim 10 to ensure data accuracy, integrity, and longevity.

5. The steps and methods of conducting a Voting Session of claims 1,2,3,4 whereby any number of Officials use Voter lists of claim 1 to determine, assign, sort, organize, package, deliver or transmit or otherwise process according to claim 10, any number of Master Ballots of claim 4, or, any number of Master Voter Registration Applications of claim 2, or, any number of Master Voter Language forms of claim 3, or any number of other related documents of information or instruction, any number of self-addressed envelopes, any number of postage pre-paid stamped, self-addressed envelopes, and then modifying any number of attributes associated with each Master Ballot or Master Voter Registration Application using computers running programs, as well as permanently recording the issuing of each Master Ballot of claim 4 that is distributed to each Voter on each List of Eligible Voters of claim 1, or each Master Voter Registration Application of claim 2 sent to each Potential Voter on each List of Potential Voters of claim 1 and each Eligible Voter on each List of Eligible Voters of claim 1, or, each Master Voter Language form of claim 3 sent to each Potential Voter on each List of Potential Voters of claim 1 and each Eligible Voter on each List of Eligible Voters of claim 1, and then subsequently modifying and recording any number of attributes associated with each Eligible Voter and each Potential Voter in correlation with, or independent of, each Master Ballot, each Master Voter Registration form, each Voter Language form that was sent to each Eligible Voter and each Potential Voter.

6. The steps and methods of conducting a Voting Session of claims 1,2,3,4,5 whereby any number of Officials according to claims 1 to 5 perform any number of times, for any number of Potential Voters or Eligible Voters of claim 1, the steps and methods of determining, assigning, sorting, organizing, packaging, addressing, delivering or transmitting, receiving or accepting, recording and storing, tallying publishing or otherwise processing according to claim 10, any number of Master Ballots, or, any number of Master Voter Registration forms, or any number of Master Voter Language forms, or any number of related documents of information or instruction, any number of self-addressed envelopes, any number of postage pre-paid stamped, self-addressed envelopes, using any combination of, but not limited to: in person, by postal service mail, by third party delivery service, by designated representative (proxy), electronically using any number or combination of computers, microprocessors, computer software programs, telephones, facsimile (fax) machines or software, optical scanners, computer programs, audio recording and playback systems, video recording and playback systems, communication networks, cable television systems, electronic mail encryption and decryption methods, data compression and decompression methods, data organization and retrieval using computers running software programs and any steps and methods of claim 10.

7. The steps and methods of conducting a Voting Session of claims 1,2,3,4,5,6 whereby any number of Potential or Eligible Voters receives any number of Master Ballots of claim 4, receives any number of Voter Registration forms of claim 2, or receives any number of Voter Language Forms of claim 3; and the further steps and methods whereby any number of recipients then verify any number of Ballots, forms or other documents by referring to the Election Information portion, or the Due Date portion, or the Due Time portion, or any other information provided to enable the voter to determine validation and usefulness for any ballot, form or document whereby the confirmation employs, but is not limited to, any number or combinations of—telephones, computers, computer software programs, communications networks, fax machines or fax emulation software, cable television systems, electronic mail, optical scanners, or digital cameras, to transmit and receive ballot or form information, as well as confirmation, rejection, or error messages according to claims 1,2,3,4,5,10 as to the Ballot, form or document validity, to or from, any number Election Officials or designated representatives, as well as any processing according to claim 10; and the further steps whereby any number of Eligible Voters confirm authenticity of any number of Master Ballots by referring to any number of unique Ballot RSID or any number of Security Elements or any number of published design features common to any number of Master Ballots (and thus Primary and Receipt ballots), any group of Master Ballots or any individual Master Ballot whereby Security Elements (FIG. 4 item 4a—Security Elements) are comprised of any number of: Random Symbolic Identifiers RSID's) Ballot RSID's, PassCode RSID's, physical characteristics or devices, optical structures or devices, holograms, electronic devices or structures, magnetic fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, photosensitive symbols, photosensitive text, or photosensitive images, electronic codes, optical codes, optical or digitized pictures, codes embedded within optical pictures or digitized pictures, watermarks, impressions or seals of authenticity integral, affixed or associated, and any other physical, electronic, electromagnetic, optical, chemical or biological structures, devices or properties associated with any number of Ballots (Master, Primary or Receipts or any number of Voter Registrations (Master Primary or Receipts) or any number of Voter Language forms (Master, Primary, or Receipts).

8. The steps and methods of conducting a Voting Session of claims 1,2,3,4,5,6,7 whereby any number of Voters according to claim 7 perform additional steps before revealing Ballot PassCode RSID, marking or casting their Ballots of claim 4, to determine whether any number of Master Ballots they are evaluating were not previously used to Vote, and if the Ballot is confirmed as not previously having been used to vote, the Voters exchange any number of Master Ballots they possess for other Master Ballots possessed by any number of trusted Eligible Voters or any number of Voting Session Officials or their designated agents, and the further steps and methods whereby any number of Voters either manually, or using any number of software programs and at least one optical or electronic device connected to communications networks, process according to claim 10; Inventor comments. This steps and methods are unique among inventions to preserve the anonymity of any Voter, and thus, every Voter, since Voting Session Officials cannot determine which Voters used these steps/methods; In essence, Ballots are like treated like currency, whereby any Eligible Voter can use the Master Ballot, which would be exchanged in kind for an identical Master Ballot in a Voting Region-Zone, as per the Election Rules; Even if a PassCode RSID were revealed, the voter can determine electronically or in person, whether the Master Ballot has already been used to Vote; Publication of some of the Security Elements such as holograms, special currency-like paper, the extremely hard to guess (thus hard to fake) traceable Ballot RSID, and dealing with known to be trustworthy people, assist Voters to ensure they exchange their Master Ballot(s) for valid, authentic Master Ballot(s).

9. The steps and methods of conducting a Voting Session of claims 1,2,3,4,5,6,7,8 whereby any number of Voters according to claim 8, who are deemed Eligible Voters or Proxy Voters, completes any number of Master Ballots, keep any number of Receipt Ballots, then send, transmit, or deliver in person or by mail or designated third party, or transmits optically according to claim 10, or transmits electronically according to claim 10, or transmits optically-electronically according to claim 10, or by any other acceptable means conveys, any number of Primary Ballots, Receipt Ballots or Master Ballots to any number of Officials or any number of Officially designated Receivers of Ballots according to the rules of the current Voting Session; and the further steps and methods according to claim 7, whereby any number of Voters of claim 1 complete any number of Master Registration forms of claim 2, then keep any number of Receipt Registration forms, then send, transmit, or deliver in person or by mail or designated third party, or transmits optically, or transmits electronically, or transmits optically-electronically, or by any other acceptable means conveys, or processes according to claim 10, any number of Primary Registration forms, Receipt Registration forms or Master Registration forms to any number of Officials or any number of Officially designated Receivers of Registration forms according to the rules of the current Voting Session; and the further steps and methods according to claim 7, whereby any number of Voters of claim 1, complete any number of Master Language forms of claim 2, then keep any number of Receipt Registration forms, then send, transmit, or deliver in person or by mail or designated third party, or transmits optically according to claim 10, or transmits electronically according to claim 10, or transmits optically-electronically according to claim 10, or by any other acceptable means conveys, any number of Primary Language forms, Receipt Language forms or Master Language forms to any number of Officials or any number of Officially designated Receivers of Language forms according to the rules of the current Voting Session.

10. The steps and methods of conducting a Voting Session of claims 1 to 20 whereby processing of Ballots, forms, documents or any other form of information comprises of (but is not limited to) the steps and methods of: researching, identifying, defining, designing, verifying, correlating, authenticating, amending, certifying, preparing, organizing, sorting, assembling, recording, storing, printing, publishing, distributing, receiving, creating, assigning, attaching, linking, embedding, encoding, decoding, encrypting, decrypting, compressing, decompressing, converting, accepting, receiving, recording, electronic scanning, optically scanning, recording, enhancing, storing, creating any number of identical duplicate backup copies, correlating, tallying, counting, calculating, correlating, associating, searching, sorting, organizing, marking, labeling, tagging, identifying, acknowledging, error identification, error recording, error correction, error transmission, error reception, error reporting, authenticating, verifying, validating, certifying, summarizing, reporting, communicating, printing, publishing, transmitting, receiving, compressing, decompressing, encrypting, decrypting, interpreting, converting, locating, detecting, reading, receiving, interpreting, translating, transmitting data to, and receiving data from, any number of—humans, legal entities, computers, electronic, mechanical or optical devices, telephones, communications networks and is to include all steps and methods of translating human and device readable codes to modes, protocols or methods of communication, transmission, reception, decryption, encryption, compression, decompression, as well as the steps and methods of locating, receiving, detecting, interpreting, translating, reporting, and transmitting error free data, and the further steps of locating, receiving, detecting, interpreting, translating, reporting transmitting, and correcting compromised data, erroneous data, duplicate data or duplicate transmissions; and the further steps and methods, whereby the aforementioned functions, operations and processing of this claim are performed by (but not limited to) any combination and any number of either singularly or any plurality of—Official persons, designated agents, data acquisition devices, electronic, electromagnetic, optical or biological or other computing or analytical devices, communication networks, any other man-made devices, computers, microprocessors, computer software programs, telephones, facsimile (fax) machines, fax software, optical scanners, audio recording equipment, audio playback systems, video recording equipment, video playback systems, communication networks, cable television systems, electronic mail, data encryption methods, data decryption methods, data conversion methods, data reconstruction methods, data compression methods, data decompression methods, data inventory software, data organization software, data tracking software, data retrieval software, printing software, printers, package labeling software and equipment, package identification software, package tracking software, either separately, or, in combination with of any number of Security Elements of claim 7.

11. The steps and methods, according to steps 9 whereby Officials do accept, receive, acknowledge, sort, organize, record, store, tally, calculate, summarize, print or publish or otherwise process according to step 10, any number of Voter Registrations (Master, Primary, Receipts) of claim 2, any number of Voter Language (Master, Primary, Receipts) of claim 3, or any number of Ballots (Master, Primary, Receipts) of claim 4; and the further steps and methods whereby each received Voter Registration form, each Voter Language form, or each Ballot is assigned a new, unique record in a record system which comprises of a new record identifier, date, time, location, and any number of other attributes are updated to describe the receiver and various status conditions for each unique Ballot, Registration or Language form;—any number of Ballots, any number of Voter Registrations, any number of Voter Language forms—of which processing for Ballots includes (but is not limited to), each portion containing any number of candidates, proposals or candidates and proposals correlated with any number of barcodes and further correlated with a portion of the area assigned to mark or record each voter selection, voting information including (but not limited to) at least one voting region identifiers (a.k.a. primary voting zones), any number of subsidiary voting region identifiers (a.k.a. secondary voting regions-zones), any number of polling station identifiers, any number of postal code identifiers, any number of zip codes identifiers, any number of geographic location identifiers, any number of election type identifiers, any number of due date identifiers, any number of due time identifiers, any number of expiry date identifiers, any number of expiry time identifiers, any number of election identification identifiers, any number of other codes or other identifiers, any number of any number of Security Elements, at least one Ballot RSID or Registration RSID, any number of PassCode RSIDs;—of which processing for any number of Voter Registrations includes (but is not limited to) processing any number of personal identifiers, any number of printed names, any number of signatures, any number of date information, any number of location information; any other Registration information;—of which processing for any number of Voter Language forms includes (but is not limited to) processing any number of personal identifiers, any number of Voter Language Selections information, any number of date information, any number of location information; any other Language information; as well as the steps and methods for each Ballot, Registration or Language form of correlating of each aforementioned identifier or to the respective barcodes or other optical scanning markings or encodings, or electronic processing markings or encodings; and the further steps and methods of creating, assigning, attaching, linking and processing additional encoding for electronic or optical submissions to ensure accurate processing according to claim 10; and the further steps and methods of data storage, retrieval and organization of received Ballots, Voter Registrations and Voter Language forms so as to be easier to record, tally, identify, sort, store, locate, retrieve, publish or otherwise process according to claim 10; and the further steps and methods whereby Officials create, distribute and otherwise process (according to claim 10) any number of acknowledgements for each Master Voter Registrations, Primary Voter Registrations, Receipt Voter Registrations, Master Ballots, Primary Ballots, Receipt Ballots, Master Voter Language forms, Primary Voter Language forms, Receipt Voter Language forms, received from any number of Eligible Voters of claim 1, any number of Potential Voters of claim 1, or any number of Ineligible Voters of claim 1, and any number of designated representatives (proxies) or any other approved legal entities of claim 1.

12. The steps and methods, according to claims 10 and 11, whereby any number of times, for each Ballot or each Voter Registration or each Voter Language form that is received and found to contain an RSID or any other ID that is determined to have been previously submitted, the Ballot or form is identified, uniquely marked, recorded, tallied, removed and stored separate from all tallies of valid, authenticated, certified ballots, for further investigation along with all other Ballots sharing the same unique RSID or Voter Registration ID or Voter Language ID, as well as the further steps and methods of determining, any number of times, the truly authentic, valid, certifiable Ballot or Voter Registration, from a group of duplicate submissions, and the further step of restoring each authentic, valid, certifiable Ballot or Voter Registration or Voter Language form to normal processing steps associated with all valid, authentic, certified Ballots or Voter Registrations or Language forms.

13. The steps and methods according to claims 10, 11 and 12 whereby Officials provide any number of times, any number of copies of each Ballot or Voter Registration or Voter Language forms that is received, such that each aforementioned copy is made available to at least one Eligible Voter for verification and error detection, and that at least one means, method and opportunity of reporting errors is provided, and the further steps and methods whereby any number of Officials, or any number of Eligible Voters, or at least one designated representative (proxy) that possess the unique combination of the Ballot RSID and PassCode RSID for each disputed Voter Registration or Ballot submits the Voter Registration or Ballot electronically to Officials using, but not limited to, any number or combinations of: telephones, computers, computer software programs, communications networks, fax machines or fax emulation software, cable television systems, electronic mail, optical scanners, digital cameras, as well as software and devices for detecting, correcting and recording any errors of content or transmission, or, any number of errors are reported by presentation of the sufficiently intact physical Ballot (Master, Primary or Receipt) of claim 4 or the Voter Registration (Master, Primary, or Receipt) of claim 2, or Voter Language forms (Master, Primary, Receipt) of claim 3, by any number of Potential Voters, Eligible Voters or designated representative (proxy) Voters of claim 1, for each disputed Voter Registration, for each disputed Voter Language form or for each disputed Ballot.

14. Officials record and provide a receipt for each Eligible Voter of claim 13, or, to each Voter of claim 1, or to any number of Officials, requesting investigation of errors or omissions pertaining to Voter Registrations (Master, Primary, Receipts) or Ballots (Master, Primary, or Receipts) or both Voter Registrations and Ballots, along with all relevant details, then Officials or their designated agents proceed to investigate whether to accept or reject each Voter request to amend any errors, record the Official findings of the investigation, and when required, Officials amend any number of disputed records, tallies, summaries, calculations, and publications for any number of Voter Registrations (Master, Primary, Receipts) or Ballots (Master, Primary, or Receipts), in accordance with the findings and Voting Session Rules, then any number of times, Officials verify each amendment was completed accurately, or resubmit any number of amendments, then provide a report to each complainant Voter and any number of other interested parties.

15. The steps and methods, of claims 1 to 14, whereby for any number of persons or other legal entities that has access to any electronic, electromagnetic, optical, digital, or any other transformed version of any printable Ballot, Form, Sheet or Document of this invention, the Officials will provide an unalterable, immutable form or representation of any number of accessible information items that are identified as Crucial Integrity Data Items, such as, but not limited to, the main identification RSIDs for each and every—Ballot, Voter Registration Form, Voter Language Form, Voter Ballot Data Form, Voter Information Document, or any other documents or forms of this invention.

16. The further steps and methods of claim 4 whereby the Master Ballot comprises of a Primary Ballot, at least one Receipt Ballot, at least one unique Ballot RSID that is extremely difficult to guess, and at least one PassCode RSID that is difficult to guess; and the further steps and methods whereby the Ballot RSID is printed on the outside of a sealed container (such as, but not limited to—a paper envelope, an electronic encrypted container (such as, but not limited to a secure webpage linked to a secure email postbox)) along with details of the voting session (such as, but not limited to—election description, ballot voting region, poll station, candidates, due date and due time) and at least one Security Elements of claim 4 (such as, but not limited to holograms, Ballot RSID); and the further steps and methods whereby the Primary Ballot, Receipt Ballot(s) and the PassCode RSID are all contained within the Master Ballot sealed container; and the further steps and methods of claim 8 whereby the Voter does NOT open the Master Ballot sealed container to verify the validity of the Ballot; and the further steps and methods of claims 5-15 whereby the Voter does use the information and security elements displayed on the exterior of the Master Ballot sealed container to verify the Ballot usefulness and validity; and the further steps according to claims 5 to 15 whereby to cast a Ballot, the Voter opens the Master Ballot sealed container, then completes and delivers the Primary Ballot and retains at least one Receipt Ballot; and the further steps and methods whereby the Voter is enabled to vote either in person, by mail, or electronically after revealing, viewing and using the PassCode RSID found within the Master Ballot sealed container, or printed on the Primary Ballot or printed on the Receipt Ballot, in conjunction with the Ballot RSID for that same Master Ballot, Primary Ballot or Receipt Ballot; and the further steps and methods whereby if the Master Ballot container is a paper or plastic envelope, the container is perforated along at least one edge to ease opening and prevent or mitigate damage to either Primary Ballot or Receipt Ballots, and the further steps and methods whereby if the Master Ballot container is electronic, that Security Elements of claim 4, and steps and measures of claim 10 will ensure the protection of sensitive data also ensuring data integrity, accuracy and longevity.

17. The right to amend this claim at a later date.

18. The right to amend this claim at a later date.

19. The steps and methods whereby Officials and Voters repeat any number of steps 1 to 18, any number of times, until satisfied according to Voting Session Rules.

20. Officials then verify, validate, certify then publish the final amended records, tallies, calculations, summaries and reports pertaining Voter Registrations, Ballots, and any other relevant aspect of the Voting Session, in accordance with the Rules of the Voting Session, then declaring the current Voting Session to be completed and closed.
